(19) United States
(12) Patent Application Publication
(10) Pub. No.: US 2013/0238300 A1
(43) Pub. Date: Sep. 12, 2013

(54) RECORDING MEDIUM, LIBRARY GENERATION APPARATUS, AND POWER CONSUMPTION CALCULATION APPARATUS

(71) Applicant: FUJITSU LIMITED, Kawasaki-shi (JP)

(72) Inventor: Motohiro OZAWA, Musashino (JP)

(73) Assignee: Fujitsu Limited, Kawasaki-shi (JP)

(21) Appl. No.: 13/854,304

(22) Filed: Apr. 1, 2013

Related U.S. Application Data
(63) Continuation of application No. PCT/JP2010/067803, filed on Oct. 8, 2010.

(51) Int. Cl. G06F 17/50

(52) U.S. Cl. CPC G06F 17/5045
USPC 703/2

(57) ABSTRACT

A system to which the present invention has been applied obtains range information representing a range of an evaluation condition under which a power consumption value of a semiconductor device is calculated, sets an expression for calculating a power consumption value of a cell under an evaluation condition within the range represented by the range information for each cell, which is a basic element constituting the semiconductor device, and generates a library that has stored mathematical expression information representing the set mathematical expression for each of the cells.

### CROSS-REFERENCE TO RELATED APPLICATION

This application is a continuation application of International PCT Application No. PCT/JP2010/067803 which was filed on Oct. 8, 2010.

### FIELD

The embodiments described herein are related to a technique of evaluating power consumption of a semiconductor device.

### BACKGROUND

Semiconductor devices, represented by LSI, have achieved higher speeds and higher integration. Accompanying this, power consumption in semiconductor devices has increased. Accordingly, in order to meet the demand for saving power, power consumption is usually evaluated (estimated) in parallel to the designing of semiconductor devices.

A semiconductor device is usually designed by combining cells, which are registered as basic elements. A cell is a constituent that can be treated as a unit of logical or functional aspects of a semiconductor device, and not only basic gates such as OR gates, NOR gates, AND gates, NAND gates, etc., but also large scale constituents such as PLLs or memories are usually treated as cells. Accordingly, as a method of calculating power consumption of a semiconductor device, a method is widely accepted in which a library that has stored pieces of power consumption data for power consumption calculation is prepared for each cell that constitutes the semiconductor device, and a power consumption value is calculated for each of the cells by referring to the library. According to this method, a value obtained by adding the power consumption values for the respective cells is treated as the total power consumption value of the semiconductor device.

A plurality of cells of the same type are set in a semiconductor device. Cells of the same type operate in different ways in accordance with the locations that they are disposed in, and consume different levels of power. In order to discriminate cells of the same type, each cell that has been set in a semiconductor device is referred to as an “instance” hereinafter.

The power consumption of a cell (instance) can roughly be categorized into two types: leakage power and dynamic power. Leakage power is power consumed as a leakage current. Dynamic power is power consumed by operations of charging and discharging load capacity and by flow-through power when the operation status of a cell transitions. Transitions of operation statuses depend upon the current status of a cell (referred to as an “internal state” hereinafter) or input signals.

In a conventional library, the power consumption value of a cell has been defined as power consumption data of that cell. Leakage power of a cell varies in accordance with the internal state of the cell or input conditions of signals. Accordingly, the value of power consumption caused by leakage power is usually defined for each internal state, each input condition, or each combination of these.

FIG. 1 illustrates an example of a conventional description of power consumption data that defines a power consumption value of leakage power.

The description example illustrated in FIG. 1 treats a cell labeled “NAND2” (NAND gate). Cell “NAND2” includes two input terminals: one is labeled “A1” and the other is labeled “A2”. Accordingly, three input conditions are defined: the first is a case in which signals input to input terminals A1 and A2 are H (logical value is 1), the second is a case in which signals input to input terminal A1 are H while signals input to input terminal A2 are L, and the third is a case other than the first two cases (default case). For these input conditions, 20.0, 10.0, and 15.0 are respectively defined as the power consumption values (in units of, for example, nW).

The power consumption value under the default condition is defined by the description between “cell_leakage_power:” and the first “;”. Under conditions other than the default condition, input conditions are defined in addition to the power consumption value. These input conditions and the power consumption value are defined in the curly brackets that follow “leakage_power( )”. The input conditions are defined by the description between “when:” and the first “;”, and the power consumption value under the defined input condition is defined by the description between “value” and the first “;”.

It is possible to determine the leakage power (power consumption value) in relation to an input condition by referring to the power consumption data described as illustrated in FIG. 1. The reason why the internal state is not defined in the power consumption data in FIG. 1 is that the internal state of a NAND gate only varies in accordance with input conditions.

Dynamic power varies in accordance with a transition time over which signal levels vary and in accordance with a load capacity. A transition time and a load capacity have arbitrary values. Accordingly, a power consumption value based on dynamic power is defined by a look-up table (referred to as a “LUT” hereinafter) having a transition time and a load capacity as variables (parameters).

A transition time is defined as a time taken that a signal varies from one level to a different level. More specifically, when, for example, the level of a signal in an L state is zero and the level of the signal in an H state is 100, a time taken that the signal varies from, for example, level 20 to level 80 is defined as a transition time (referred to as a “rising transition time” hereinafter) during the variation from L to H of the signal. Similarly, a time taken that the signal varies from level 80 to level 20 is defined as a transition time (referred to as a “falling transition time” hereinafter) during the variation from H to L.

FIG. 2 illustrates an example of a conventional description of a power consumption value of dynamic power.

Similarly to FIG. 1, FIG. 2 illustrates an example of a cell labeled “NAND2” (NAND gate). The name of the output terminal of cell “NAND2” is “X”. In this example, two LUTs are defined for dynamic power that is generated by signals input to input terminal A1. The description in the curly brackets following “rise_power” defines LUTs when signals are rising. The description in the curly brackets following “fall_power” defines LUTs when signals are falling.

The two LUTs define power consumption values for combinations of two variables denoted by “index_1” and “index_2”. “index_1” is the name of a variable representing, for example, a transition time, and 0.01, 0.02, and 0.04 are defined in FIG. 2 as three values for this variable (in units of, for example, ns). “index_2” is the name of a variable representing, for example, a load capacity, and 0.01, 0.02, 0.04, and 0.05 are defined as four values for this variable in FIG. 2 (in units of, for example, pF). Accordingly, in each of the LUTs, a total of twelve (12=3×4) power consumption values are defined in the curly brackets following “values”. The unit of the power consumption values is, for example, μW.

The respective power consumption values are described in pairs of double quotation marks with commas between them. In the curly brackets following “values”, “¥” marks are written between pairs of double quotation marks. Because of this positional relationship, “¥” marks are ignored as data. “¥” at an end of a sentence indicates that a next sentence is continuous to a former sentence. Although line feed at parenthesis after “values” is ignored according to the format, line feed is performed by inserting “¥” at an end of a sentence in order to increase intelligibility of data. With “¥” marks being inserted, the power consumption values are described in groups each having four power consumption values. The first group of the four power consumption values is for the transition time of 0.01 ns, the second group is for the transition time of 0.02 ns, and the last group is for the transition time of 0.04 ns.

As described above, transition times and load capacities have arbitrary values. Accordingly, when either a transition time or a load capacity has a different value from variables in the LUTs, a value obtained by interpolation is used as a power consumption value. Thereby, it is possible to determine a dynamic power value (power consumption value) in accordance with a transition time and a load capacity by referring to power consumption data described as illustrated in FIG. 2.

Leakage power and dynamic power both vary in accordance with variations in PVT (Process, Voltage, and Temperature), and specifically, processes for producing a semiconductor device, voltages applied to cells constituting the semiconductor device, and temperatures of the cells. Accordingly, today, power consumption is estimated taking variations in PVT into consideration. Because of this, variations in PVT are treated as conditions under which power consumption is calculated. These conditions are referred to as PVT conditions hereinafter.

The above library is generated by executing simulation (such as, for example, a device simulation) for confirming the power consumption of a cell. In such a case, a PVT condition and an LUT generation condition are given together with an input condition and an internal condition as conditions under which simulation is executed. An LUT generation condition specifies a power consumption value to be defined on an LUT, and includes, for example, values of respective variables, i.e., values defined by “index_1” and “index_2” in FIG. 2. Thereby, simulation is conducted for each combination of values of respective variables. A conventional method of calculating a power consumption has been conducted in an order of execution of simulation on the basis of execution conditions including a PVT condition and an LUT generation condition (generation of library), calculation of a power consumption value for each instance, and calculation of the power consumption value of the entire semiconductor device.

FIG. 3 explains the configuration of a conventional power consumption calculation apparatus.

PVT condition information 31 and LUT generation condition information 32 input by, for example, an operator are input to a consumed current simulation unit 33 that calculates a consumed current by executing simulation for each cell. The consumed current simulation unit 33 generates a library by executing simulation a plurality of number of times in accordance with execution conditions including PVT conditions represented by the PVT condition information 31 and LUT generation conditions represented by the LUT generation condition information 32.

An instance-by-instance power consumption calculation unit 35, provided for each instance, refers to a library for each instance that constitutes a semiconductor device so as to calculate a leakage power value and a dynamic power value. information necessary for calculating leakage power and dynamic power such as the input condition, the internal states or the like are set, for example, for each instance. The power consumption value of each instance is calculated by using a leakage power value and a dynamic power value that have been calculated on the basis of the set information.

A power consumption value calculated for each instance is input from the instance-by-instance power consumption calculation unit 35 to an LSI power consumption calculation unit 36, and the LSI power consumption calculation unit 36 adds the input values. The result of adding the power consumption values is output as a power consumption value 37 of the entire semiconductor device.

Thereby, the power consumption value 37 of an entire semiconductor device is calculated by executing simulation under a given PVT condition, generating a library from the result of the simulation, and using the generated library. Simulation has to be executed a number of times that is determined by an LUT generation condition. Execution of simulation (generation of a library) requires a certain amount of time. Due to this, rapid calculation of the power consumption value 37 under different PVT conditions has been difficult.

A conventional library can define a derating factor related to processes, voltages, and temperatures so that power consumption can be calculated under different PVT conditions. By generating a library that has defined a derating factor, calculation of the power consumption value 37 under different PVT conditions can be performed rapidly.

A derating factor described above is usually a difference value representing the variation level of power consumption with respect to variations in process, voltage, or temperature. However, variations in power consumption values that are caused by variations in the process, the voltage, or the temperature are not linear regardless of whether the variations are in the process, the voltage, or the temperature. Accordingly, when power consumption is estimated under a PVT condition that is significantly different from the PVT condition used for generating a library, the accuracy in the estimation is highly degraded. Accordingly, it is in practice believed that estimation of power consumption under a plurality of PVT conditions that differ relatively significantly should prevent the use of a library that has defined a derating factor.

Estimation of power consumption using different PVT conditions is necessary also for the following operations among other operations. Higher integration in semiconductor devices has added to the influence of PVT conditions on power consumption. This is an important reason for conducting the following operations (1) through (3). Accordingly, it is expected that estimation of power consumption will more often be conducted while employing different PVT conditions. In this respect as well, it is important to make it possible to estimate power consumption rapidly even under PVT conditions that differ relatively significantly while maintaining high accuracy.

1) Setting power-supply voltage that meets the power limit for each process variation of a semiconductor device
2) Performing power calculation that has reflected the cooling condition of a semiconductor device
3) Performing temperature distribution analysis

As a method of estimating power consumption rapidly under various PVT conditions, a method is possible in which a library is generated for each PVT condition in advance. However, generation of a library requires execution of simulation. The number of state quantities that are conditions for executing simulation (a variable representing the contents of execution conditions) is not small. Due to this, simulation has to be executed an immense number of times, and generation of all necessary libraries takes a long period of time. Also, because LUTs are defined in libraries, a large storage capacity is necessary for storing all generated libraries.

For these reasons, a method in which a library is generated for each PVT condition in advance has to be prevented. Therefore, it is important to suppress the number of times of executing simulation and the data volume when estimating power consumption of a semiconductor device rapidly and with high accuracy under PVT conditions that differ relatively significantly.
Patent Document 1: Japanese Laid-open Patent Publication No. 2008-176440
Patent Document 2: Japanese Laid-open Patent Publication No. 2009-25884
Patent Document 3: Japanese Laid-open Patent Publication No. 10-254944
Patent Document 4: Japanese Laid-open Patent Publication No. 11-73436

### SUMMARY

A system to which one aspect of the present embodiment has been applied includes an information obtainment unit configured to obtain range information representing a range of an evaluation condition under which a power consumption value of a semiconductor device is calculated, an expression setting unit configured to set an expression for calculating a power consumption value of a cell under an evaluation condition within the range represented by the range information obtained by the information obtainment unit, for each cell, which is a basic element constituting the semiconductor device, and a library generation unit configured to generate a library that has stored, for each of the cells, mathematical expression information representing the mathematical expression set by the mathematical expression setting unit.

Another system to which one aspect of the present embodiment has been applied includes a condition obtainment unit configured to obtain an evaluation condition under which a power consumption value of a semiconductor device is calculated; a first power consumption calculation unit configured to perform calculation of a power consumption value under the evaluation condition, obtained by the condition obtainment unit, of a cell, which is a basic element included in the semiconductor device, by using a library that has stored, for each of the cells, mathematical expression information representing an mathematical expression to be used for calculating the power consumption value; and a second power consumption calculation unit configured to calculate the power consumption value under the evaluation condition of the semiconductor device by using the power consumption value calculated by the first power consumption calculation unit for each of the cells by using the library.

A system to which one aspect of the present embodiment has been applied realizes rapid and highly accurate estimation of power consumption of a semiconductor device under PVT conditions that differ relatively significantly.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a conventional description of power consumption data that defines a power consumption value of leakage power;

FIG. 2 illustrates an example of a conventional description of power consumption data that defines a power consumption value of dynamic power;

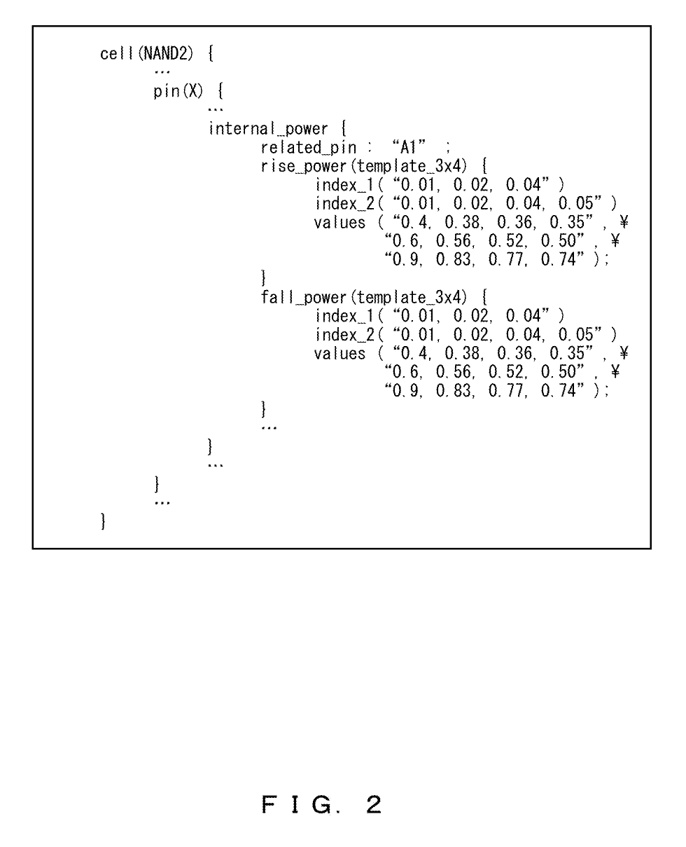

FIG. 3 explains the configuration of a conventional power consumption calculation apparatus;

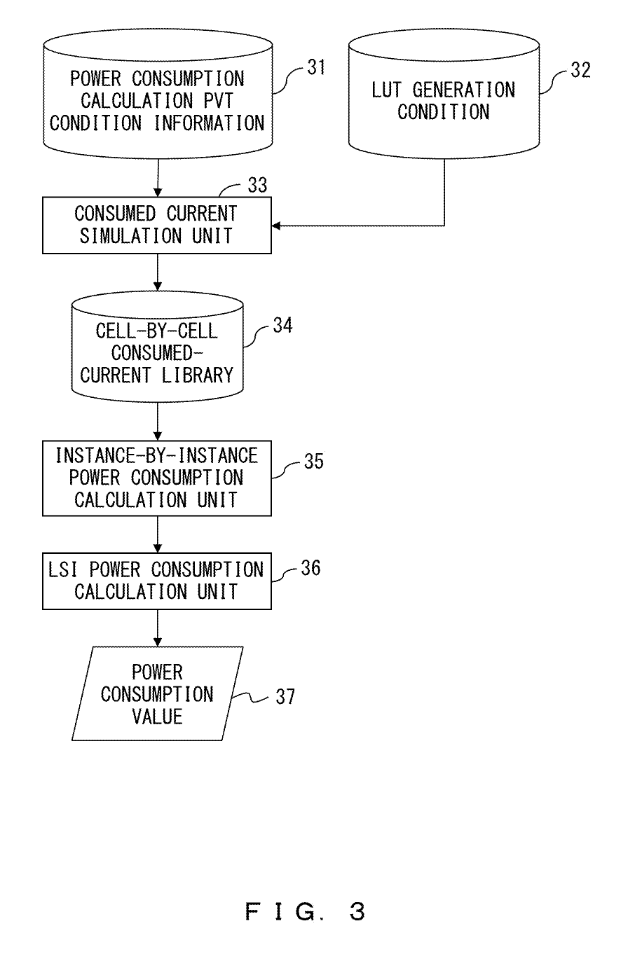

FIG. 4 illustrates a configuration of a power consumption evaluation apparatus including a library generation apparatus and a power consumption calculation apparatus according to the present embodiment;

FIG. 5 illustrates a method of measuring a leakage current, which causes leakage power;

FIG. 6 illustrates a method of measuring a dynamic current, which causes dynamic power;

FIG. 7 illustrates a method of normalizing process variations;

FIG. 8A illustrates an example of a description of leakage coefficient data;

FIG. 8B illustrates an example of a description of dynamic coefficient data;

FIG. 9A is a graph illustrating variations in a leakage current value, caused by PVT conditions, that are calculated by Expression (1) (1-1);

FIG. 9B is a graph illustrating variations in a leakage current value, caused by PVT conditions, that are calculated by Expression (1) (1-2);

FIG. 9C is a graph illustrating variations in a leakage current value, caused by PVT conditions, that are calculated by Expression (1) (1-3);

FIG. 9D is a graph illustrating variations in a leakage current value, caused by PVT conditions, that are calculated by Expression (1) (1-4);

FIG. 10A is a graph illustrating variations in a leakage current value, caused by PVT conditions, that are calculated by Expression (1) (2-1);

FIG. 10B is a graph illustrating variations in a leakage current value, caused by PVT conditions, that are calculated by Expression (1) (2-2);

FIG. 10C is a graph illustrating variations in a leakage current value, caused by PVT conditions, that are calculated by Expression (1) (2-3);

FIG. 10D is a graph illustrating variations in a leakage current value, caused by PVT conditions, that are calculated by Expression (1) (2-4);

FIG. 11A is a graph illustrating variations in a leakage current value, caused by PVT conditions, that are calculated by Expression (1) (3-1);

FIG. 11B is a graph illustrating variations in a leakage current value, caused by PVT conditions, that are calculated by Expression (1) (3-2);

FIG. 11C is a graph illustrating variations in a leakage current value, caused by PVT conditions, that are calculated by Expression (1) (3-3);

FIG. 11D is a graph illustrating variations in a leakage current value, caused by PVT conditions, that are calculated by Expression (1) (3-4);

FIG. 12A is a graph illustrating variations in a leakage current value, caused by PVT conditions, that are calculated by Expression (1) (4-1);

FIG. 12B is a graph illustrating variations in a leakage current value, caused by PVT conditions, that are calculated by Expression (1) (4-2);

FIG. 12C is a graph illustrating variations in a leakage current value, caused by PVT conditions, that are calculated by Expression (1) (4-3);

FIG. 12D is a graph illustrating variations in a leakage current value, caused by PVT conditions, that are calculated by Expression (1) (4-4);

FIG. 13A is a graph illustrating variations, caused by PVT conditions of a consumed charge quantity or other conditional variables, that are calculated by Expression (3) (1-1);

FIG. 13B is a graph illustrating variations, caused by PVT conditions of a consumed charge quantity or other conditional variables, that are calculated by Expression (3) (1-2);

FIG. 13C is a graph illustrating variations, caused by PVT conditions of a consumed charge quantity or other conditional variables, that are calculated by Expression (3) (1-3);

FIG. 13D is a graph illustrating variations, caused by PVT conditions of a consumed charge quantity or other conditional variables, that are calculated by Expression (3) (1-4);

FIG. 13E is a graph illustrating variations, caused by PVT conditions of a consumed charge quantity or other conditional variables, that are calculated by Expression (3) (1-5);

FIG. 14A is a graph illustrating variations, caused by PVT conditions of a consumed charge quantity or other conditional variables, that are calculated by Expression (3) (2-1);

FIG. 14B is a graph illustrating variations, caused by PVT conditions of a consumed charge quantity or other conditional variables, that are calculated by Expression (3) (2-2);

FIG. 14C is a graph illustrating variations, caused by PVT conditions of a consumed charge quantity or other conditional variables, that are calculated by Expression (3) (2-3);

FIG. 14D is a graph illustrating variations, caused by PVT conditions of a consumed charge quantity or other conditional variables, that are calculated by Expression (3) (2-4);

FIG. 14E is a graph illustrating variations, caused by PVT conditions of a consumed charge quantity or other conditional variables, that are calculated by Expression (3) (2-5);

FIG. 15 is a flowchart for a library generation condition determination process;

FIG. 16 is a flowchart for a leakage coefficient data registration process (extract);

FIG. 17 is a flowchart for a dynamic coefficient data registration process (extract);

FIG. 18 is a flowchart for a power consumption calculation process;

FIG. 19 illustrates an example of a hardware configuration of a computer to which the present embodiments can be applied; and

FIG. 20 is a flowchart for a power consumption calculation process (second embodiment).

### DESCRIPTION OF EMBODIMENTS

Hereinafter, embodiments of the present invention will be explained in detail by referring to the drawings.

### First Embodiment

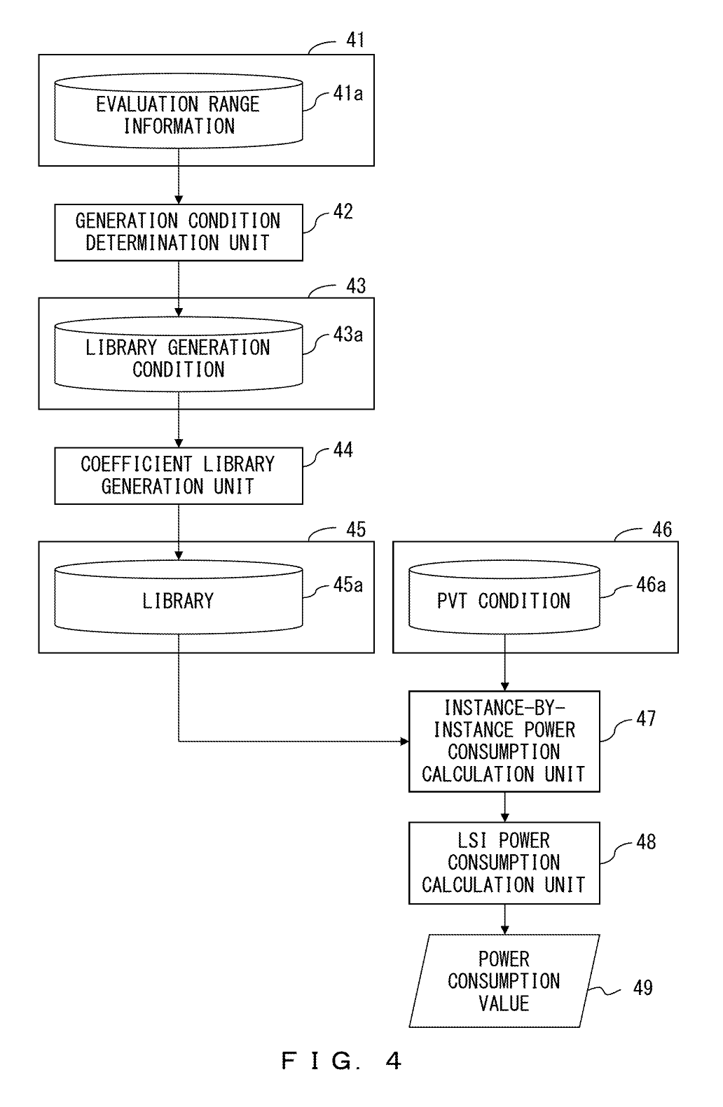

FIG. 4 illustrates a configuration of a power consumption evaluation apparatus including a library generation apparatus and a power consumption calculation apparatus according to the present embodiment. In FIG. 4, information used by the library generation apparatus and the power consumption evaluation apparatus is also illustrated schematically. The library generation apparatus according to the present embodiment is implemented as a unit that generates a library 45a for calculating the power consumption of each cell that constitutes a target semiconductor device. The power consumption calculation apparatus according to the present embodiment is implemented as a unit that calculates a power consumption value 49 of an entire semiconductor device by using the generated library 45a.

The library generation apparatus according to the present embodiment receives evaluation range information 41a so as to generate, for each cell, the library 45a that has recorded power consumption data for calculating power consumption. The library generation apparatus includes an information obtainment unit 41 that obtains the evaluation range information 41a, a generation condition determination unit 42 that generates a library generation condition 43a as a condition for generating the library 45a by referring to the evaluation range information 41a, a first storage unit 41 that stores the generated library generation condition 43a, a coefficient library generation unit 44 that generates the library 45a in accordance with the generated library generation condition 43a, and a second storage unit 45 that stores the library 45a.

The evaluation range information 41a represents a range of PVT conditions that can be used for evaluating the power consumption of a semiconductor device. The information obtainment unit 41 is a unit that has received or stored the evaluation range information 41a. In the present embodiment, a range other than PVT conditions is also specified as the evaluation range information 41a. Specifically, information that specifies the ranges of a transition time, a load capacity, and the like is also employed as the evaluation range information 41a. Hereinafter, state quantities representing execution conditions are referred to as “conditional variables”.

Specific explanations will be given for leakage power and dynamic power, which account for a large share of power consumption, before explanations are given for the contents of the evaluation range information 41a, i.e., respective conditional variables and the range of those values.

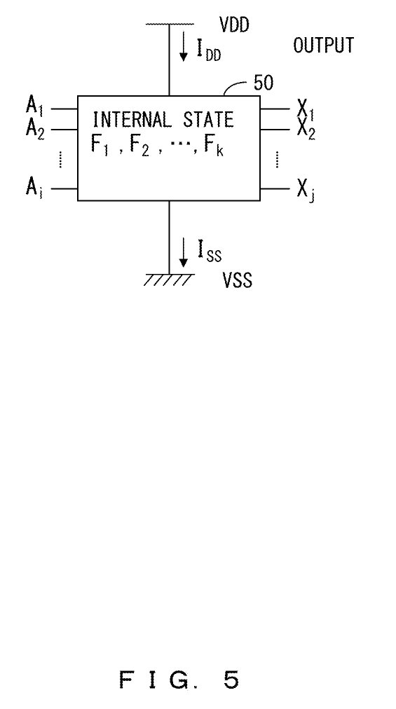

FIG. 5 illustrates a method of measuring a leakage current, which causes leakage power. In FIG. 5, “50” denotes a cell, A1 through Ai denote input terminals of the cell 50, X1 through Xj denote output terminals of the cell 50, F1 through Fk denote the internal states of the cell 50, VDD denotes a positive power-supply voltage of the positive voltage side, VSS denotes a negative power-supply voltage of the negative voltage side, I_{DD} denotes a positive power-supply current supplied from the positive voltage side to the cell 50, and I_{SS} denotes a negative power-supply current flowing from the cell 50 to the negative voltage side.

Leakage power is caused by a leakage current that flows in a situation where no signal input to the cells 50 varies. A leakage current varies in accordance with the input conditions, i.e., combinations of signals input to respective input terminals and internal states of the cells 50. Accordingly, input conditions and internal states F1 through Fk of the cell 50 are set for executing simulation (such as device simulation) on the basis of the set contents so as to calculate leakage currents. Signals output from the respective output terminals of the cell 50 are determined by the set input conditions and internal states.

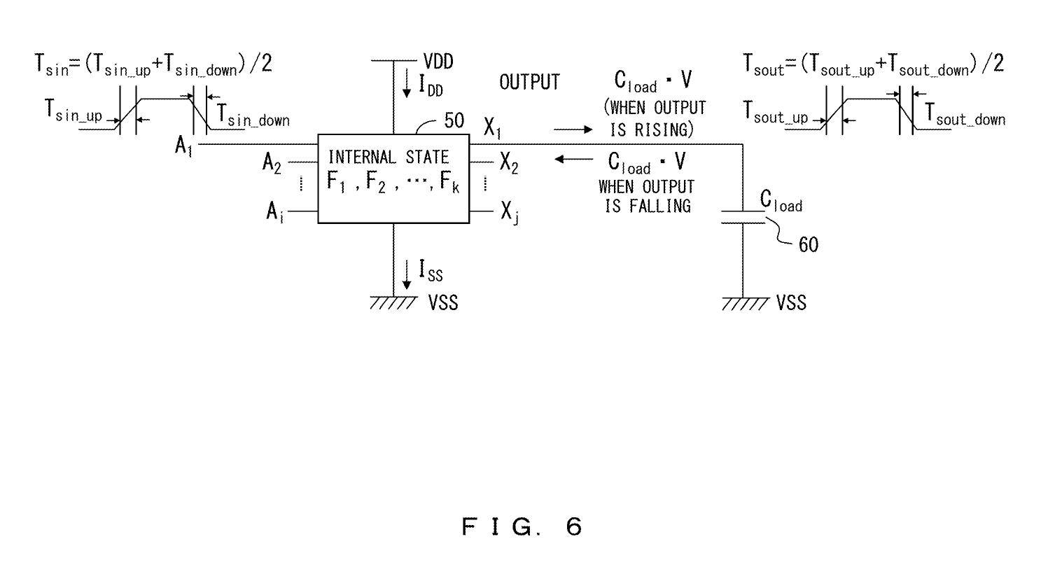

FIG. 6 illustrates a method of measuring a dynamic current, which causes dynamic power. In FIG. 6, C_{load} denotes a load capacity, V denotes a potential difference between positive power-supply voltage VDD and negative power-supply voltage VSS (referred to as “power-supply voltage” hereinafter), I_{DD} denotes a current flowing from the positive power supply side (referred to as “positive power-supply current” hereinafter), and I_{SS} denotes a current flowing to the negative power supply side (referred to as “negative power-supply current” hereinafter).

As illustrated in FIG. 6, Tₛᵢₙ_{_{—}}ᵤₚ denotes a transition time needed for a rising of a signal input to an input terminal of the cell 50, and Tₛᵢₙ_{_{—}}_{down} denotes a transition time needed for a falling of a signal input to an input terminal. Tₛᵢₙ denotes a transition time obtained by averaging Tₛᵢₙ_{_{—}}ᵤₚ and Tₛᵢₙ_{_{—}}_{down}. Similalry, Tₛₒᵤₜ_{_{—}}ᵤₚ denotes a transition time needed for a rising of a signal output from an output terminal of the cell 50, Tₛₒᵤₜ_{_{—}}_{down} denotes a transition time needed for a falling of a signal output from an output terminal, and Tₛₒᵤₜ denotes a transition time obtained by averaging Tₛₒᵤₜ_{_{—}}ᵤₚ and Tₛₒᵤₜ_{_{—}}_{down}. In the present embodiment, by calculating transition times Tₛᵢₙ and Tₛₒᵤₜ, transition times are categorized roughly into two groups, transition times of signals to be input and transition times of signals to be output. Hereinafter, the transition time of a signal to be input, which is denoted by Tₛᵢₙ, is referred to as an “input transition time”, and the transition time of a signal to be output, which is denoted by Tₛₒᵤₜ, is referred to as an “output transition time”. The other symbols in FIG. 6 denote the same elements as in FIG. 5, and explanations thereof will be omitted.

Arising transition time and a falling transition time are defined as times needed for a signal to vary from one level to a different level. When, for example, the level of negative power-supply voltage VSS is zero and the level of positive power-supply voltage VDD is 100, the rising transition time is defined as a time needed for the signal level to vary from 20 to 80. Similarly, the falling transition time is defined as a time needed for the signal level to vary from 80 to 20.

The time variation in a signal output from the cell 50 does not always correspond to that of a signal input to the cell 50. This is why two transition times, i.e., an input transition time and an output transition time, are treated as transition times in the present embodiment.

When a signal output from the cell 50 to a load 60 connected to the cell 50 varies, the load 60 charges or discharges electricity in accordance with the variation in the signal. The maximum charge that can be stored in the load 60 is a value obtained by multiplying the value of load capacity C_{load} of the load 60 with power-supply voltage V (C_{load}×V). The charge stored in the load 60 is discharged from the load 60 accompanying the falling of the level of the signal output to the load 60. Dynamic power is caused in a situation where this type of charging or discharging of the load 60 occurs. Charging by the load 60 itself does not consume power.

In the present embodiment, as conditional variables of the evaluation range information 41a, i.e., as state quantities, power-supply voltage V, input transition time Tₛᵢₙ, output transition time Tₛₒᵤₜ, and load capacity C_{load} are employed. In addition to them, process variations between semiconductor devices (chips) (referred to as “P_{chip}” hereinafter), process variations inside semiconductor devices (referred to as “P_{ocv}” hereinafter), and a junction temperature of transistors constituting a cell (referred to as “Tⱼ” hereinafter) are employed as state quantities. The evaluation range information 41a represents the value range of each conditional variable. PVT conditions are expressed by process variations P_{chip} and P_{ocv}, power-supply voltage V, and junction temperature Tⱼ of a transistor.

When a transistor is an FET (a MOS FET in most cases), a channel temperature is used in place of junction temperature Tⱼ. However, it is possible to assume that a channel temperature and junction temperature Tⱼ are equal in view of a calculation of power consumption. Accordingly, “junction temperature Tⱼ” is used to mean the temperature of the portion having the largest amount of heat in a transistor regardless of the types of the transistor. When there is a temperature that has a greater influence on the evaluation of power consumption than junction temperature Tⱼ or that enables a more appropriate evaluation of power consumption, temperatures other than junction temperature Tⱼ may be used. Temperatures of a cell are not limited to junction temperature Tⱼ.

Unlike other conditional variables, process variations P_{chip} and P_{ocv} do not have a prescribed dimension. Accordingly, the values of process variations P_{chip} and P_{ocv} are expressed by dimensionless values i.e., normalized values. Hereinafter, when both process variations P_{chip} and P_{ocv} are intended, they are referred to as “process variation P”.

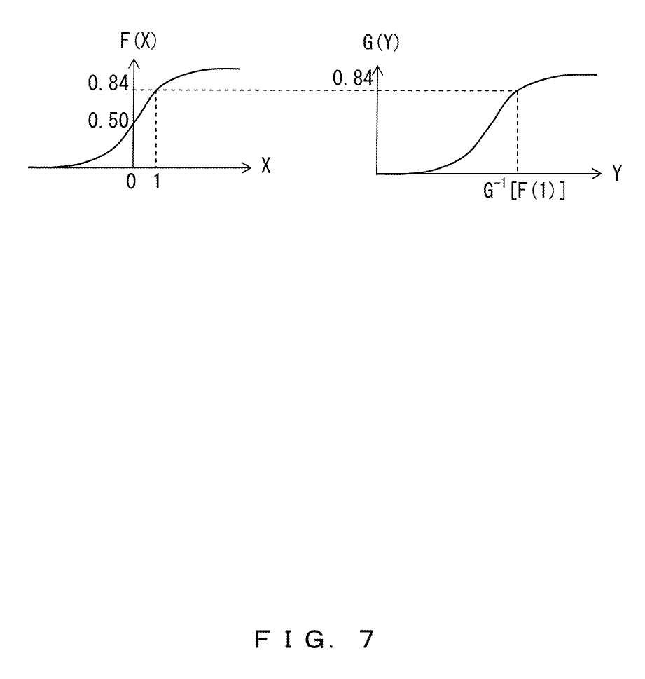

FIG. 7 illustrates a method of normalizing process variations. In FIG. 7, the left graph represents cumulative distribution function F (X) of the standard normal distribution for random variable X, and the right graph represents cumulative distribution function G(Y) of the standard normal distribution for characteristic value Y, which is to be associated with process variation P.

Characteristic value Y is a numerical value that varies in accordance with process variation P. Specifically, characteristic value Y is a characteristic value of a transistor such as, for example, the threshold voltage of a transistor or the value of a current that flows during operations of a transistor (they are both absolute values). In the present embodiment, process variation P is assumed to be in accordance with the standard normal distribution, and process variation is normalized by using characteristic value Y, which varies in accordance with process variation P. The value of process variation P corresponding to characteristic value Y is obtained as a value of a random variable X, which meets a condition that two cumulative distribution functions F(X) and G(Y) have the same value (probability).

In other words, a random variable is treated as process variation P on the basis of G(Y)=F(X) so as to satisfy Y=G⁻¹[F(P)].

FIG. 7 illustrates the relationship of G⁻¹[F(P)]=G⁻¹[F(1)] that corresponds to cumulative distribution function G(Y), which is equal to F(X)=0.84 when X(=P) is “1”.

The probability that an object will enter a certain state can be treated as information representing the probability that the object did not enter the certain state. As this example indicates, it is possible to interpret a probability from different view points. Therefore, the probability represented by cumulative distribution function F(X) for random variable X can be interpreted in two ways. Because of this, in the present embodiment, the relationship between random variable X and characteristic value Y such that the greater the value of random variable X, the smaller the absolute value of characteristic value Y is taken into consideration. By this consideration, when, for example, the value (absolute value) of a current flowing during operations of a transistor is employed as characteristic value Y, the value of process variation P becomes smaller accompanying an increase in the current value (absolute value).

Any state quantities may be employed as characteristic value Y as long as they vary in accordance with process variation P, and are not particularly limited. Also, methods other than the above may be employed for quantifying process variation P. For example, it is also possible to quantify (model) influence on power consumption by process variation P so that the value corresponding to assumed process variation P can be obtained directly.

The generation condition determination unit 42 illustrated in FIG. 4 receives evaluation range information 41a represented by the above conditional variables from the information obtainment unit 41, and determines the step size for each conditional variable on the basis of the range of the values so as to determine combinations of values of the respective conditional variables. Combinations of values of the respective conditional variables are a condition for executing simulation for generating the library generation condition 43a. Combinations of values of the respective conditional variables, i.e., a condition for executing simulation, are for example as follows. Note that the evaluation range information 41a may represent a combination of values for each of the conditional variables below.

### P_{chip:-}3, −1.5, 0, 1.5, 3

### P_{ocv}:−3, −1.5, 0, 1.5, 3

### V(V):0.8, 0.9, 1.0, 1.1, 1.2

### Tⱼ(° C.):25, 45, 65, 85, 105

### Tₛᵢₙ(ps):5, 10, 20, 40, 80

### Tₛₒᵤₜ(ps):5, 10, 20, 40, 80

C_{load} (pF):0.005, 0.01, 0.020, 0.050, 0.100

The generation condition determination unit 42 executes simulation for each of the determined execution conditions, and extracts candidates for the library generation condition 43a from among the determined execution conditions. Simulation is performed for a plurality of cells selected from all cells. As driving forces of a cell, for example two types of driving forces, that is, the maximum driving force and the minimum driving force, are assumed. Cells include, for example, an inverter, a buffer, a NAND gate, an AND gate, a NOR gate, an OR gate, an XOR gate, an XNOR gate, and a selector. When two types of driving forces are assumed for these nine types of cells, there are eighteen (9×2=18) types of cells.

In the present embodiment, the values of the leakage power and the dynamic power of each cell are assumed to be calculated by mathematical expressions using at least one conditional variable that represents the contents of the evaluation range information 41a. Examples of these mathematical expressions are as below.

Iₗₑₐₖ=exp(A+B·V+C/(Tⱼ+273)+D·V/(Tⱼ+273)+E·P_{chip}+F·P_{ocv}) (1)

I_{dyn}=Q_{dyn}/T_{sw} (2)

Q_{dyn}=Cᵢₙₜ·V+(Kₛᵢ·Tₛᵢₙ+Kₛₒ/Tₛₒᵤₜ+Kₛₓ·Tₛᵢₙ²/Tₛₒᵤₜ)·[K_{c}+exp(Kₚ·P_{chip}+Kᵥ·V+Kₜ/(Tⱼ+273))] (3)

In the above mathematical expressions, Iₗₑₐₖ is a leakage current value, I_{dyn} is a dynamic current value (amount of consumed current not including the leakage current when input data has switched by one cycle for P_{chip}, P_{ocv}, V, Tⱼ, Tₛᵢₙ, or Tₛₒᵤₜ), T_{sw} is a period of one cycle of variation in a signal input to a cell (switching period), and Q_{dyn} is a consumed charge quantity that does not include a leakage current when input data has switched by one cycle for P_{chip}, P_{ocv}, V, Tⱼ, Tₛᵢₙ, or Tₛₒᵤₜ). A, B, C, D, E, F, Cint, Ksi, Kso, Ksx, Kc, Kp, Kv, and Kt are all coefficients.

Expression (1) is based on a consideration of the influence of process variations P_{chip} and P_{ocv} and junction temperature Tⱼ in addition to power-supply voltage V on an assumption that leakage current value Iₗₑₐₖ varies in accordance with power-supply voltage V. In Expression (3), the value of the first term on the right side is the reference value of the charges, and the value of the second term on the right side is an adjustment from the reference value. The adjustment of charges is assumed to vary in accordance with input transition time Tₛᵢₙ, output transition time Tₛₒᵤₜ, process variation P_{chip} power-supply voltage V, and junction temperature Tⱼ. Adjustment is based as well on an assumption that currents vary in an exponential fashion in accordance with power-supply voltage V. It is assumed that the influence of process variation P_{ocv} on dynamic power can be ignored. Expression (2) is created on an assumption that dynamic current value I_{dyn} that is caused to flow by consumed charge quantity Q_{dyn} during switching time T_{sw} is consistent. Current values Iₗₑₐₖ and I_{dyn} are calculated by using Expressions (1) and (2) so that a leakage power value and a dynamic power value can be calculated in accordance with power-supply voltage V.

Note that the expressions for calculating leakage current value Iₗₑₐₖ and dynamic current value I_{dtyn} (consumed charge quantity Q_{dyn}) are not limited to those above. In other words, different expressions may be employed by using a modeling method. A different expression may be used for each cell. As an example of a different expression for leakage current value Iₗₑₐₖ, the expression below may be used.

Iₗₑₐₖ=exp(A+B·V+C/(Tⱼ+273)+D·V/(Tⱼ+273)+E·P_{chip}+F·P_{ocv}+G·P_{chip}·P_{ocv}+H·V·P_{chip}+J·V·P_{ocv}+L·P_{chip}/Tⱼ+273)+M·P_{ocv}/(Tⱼ+273)) (4)

In the above expression, G, H, J, L, and M are all coefficients. The number “273” is a value for converting temperature into absolute temperature.

The library generation condition 43a for which candidates are extracted by the execution of simulation by the generation condition determination unit 42 expresses an execution condition group for executing simulation in order to determine the values of the respective coefficients of Expressions (1) and (3). A candidate can be one of the execution conditions in an execution condition group.

Expression (1) includes four conditional variables, while Expression (3) includes six conditional variables. Each conditional variable has five values. Accordingly, Expression (1) requires 625(=5⁵) conditions for executing simulation, while Expression (3) requires 15625(=5⁶) conditions for executing simulation. Thereby, the generation condition determination unit 42 executes simulation at least 16250(=625+15625) times for each selected cell. Candidates for library generation conditions are extracted for each expression.

The above 625 conditions and 15625 conditions are the minimum numbers of execution conditions for executing simulation for each expression for one cell. In practice, in each cell, simulation is executed a number of times obtained by multiplying the minimum number of execution conditions with the number of input conditions, the number of internal states, etc., of a target cell. It is herein assumed that differences among cells are ignored unless otherwise noted. In other words, explanations will be given on an assumption that simulation is executed as many times as the minimum number of execution conditions in each cell unless otherwise noted.

The evaluation range information 41a includes seven conditional variables. Accordingly, there is a maximum of 78125(=5⁷) combinations of values of conditional variables. However, when the simulation necessary for each expression is executed as described above, the number of times of executing simulation falls to less than that number of combinations. This is the reason for executing the necessary simulation for each expression.

Expression (1) includes six coefficients. It is desirable that the results of at least six simulations under different execution conditions be used for calculating the values of those six coefficients. According to the present embodiment, as many execution conditions as twice the number of coefficients are extracted as candidates in order to achieve a higher accuracy. Thereby, the generation condition determination unit 42 extracts, for example, twelve execution conditions as candidates for the library generation condition 43a to be used in Expression (1). Similarly, Expression (3) includes eight coefficients, and accordingly, for example, sixteen execution conditions are extracted as candidates for library generation conditions to be used for Expression (3).

Hereinafter, the number of execution conditions extracted as candidates for each expression is referred to as a “candidate condition number”. A candidate condition number is a number of execution conditions extracted as the library generation condition 43a. Thereby, the library generation condition 43a represents execution conditions that exist in a candidate condition number for each expression.

The library generation condition 43a for an individual expression, i.e., as many execution conditions as the candidate condition number, is extracted from among as many execution conditions as a plurality of candidate condition numbers by using the results of a simulation. Extraction of execution conditions is conducted by, for example, evaluating an error between each of the execution conditions that exists in a candidate condition number and a simulation result, and determining as many execution conditions as a candidate condition number that leads to a smallest error for the value of each coefficient. The generation condition determination unit 42 thereby determines as many execution conditions as a candidate condition number that result in a higher accuracy for each cell and each expression, and stores the determination results as the library generation condition 43a in a first storage unit 43.

Calculation of the value of each coefficient in the respective expressions is conducted by performing fitting, i.e., obtaining an expression that best fits the simulation result. Methods of performing fitting are not particularly limited.

Execution conditions for simulation may be selected in such a manner that, for example, values of respective conditional variables vary in a similar manner. It is also possible to select execution conditions randomly without setting rules or the like for selecting execution conditions. As a method of evaluating errors, there is a method in which the square-root of a sum of squares of an error is obtained. However, there are no particular limitations on methods of evaluating errors.

Even when “5” is selected as the number of values of each conditional variable as described above, the number of execution conditions of a simulation increases. This leads to a requirement of a very long period of time to execute simulation when simulation is executed for all execution conditions of all cells (the number of execution conditions determined for each expression). Accordingly, in the present embodiment, the generation of the library generation condition 43a, i.e., the extraction of execution condition groups for simulation for calculating the values of the respective coefficients in Expressions (1) and (3), is conducted for only a plurality of cells that have been selected from among all cells. By suppressing the number of times of executing simulation, the library 45a can be generated within a shorter period of time while reducing errors.

In the present embodiment, simulation is executed as many times as the number of all the execution conditions for simulation for each cell. The purpose of this is to make it possible to evaluate errors of all execution conditions. A criterion may be set for execution conditions for simulation for which errors are evaluated. By setting a criterion for execution conditions, the number of times of executing simulation is reduced, and accordingly it is also possible to employ a configuration in which the library generation condition 43a is generated for all cells or for a greater number of cells that are relatively important.

The coefficient library generation unit 44 refers to the library generation condition 43a stored in the first storage unit 43, and performs calculation of the values of coefficients of Expressions (1) and (3) so as to store the calculated values in the library 45a. The library 45a is generated by storing the values of the respective coefficients of all cells. The coefficient library generation unit 44 stores the generated library 45a in the second storage unit 45. Values of respective coefficients are referred to as “coefficient data” hereinafter. Coefficient data for Expression (1) is referred to as “leakage coefficient data” while coefficient data for Expression (3) is referred to as “dynamic coefficient data” so that they are discriminated. “Coefficient data” is used to mean data including both of the above two types of coefficient data when they do not have to be discriminated.

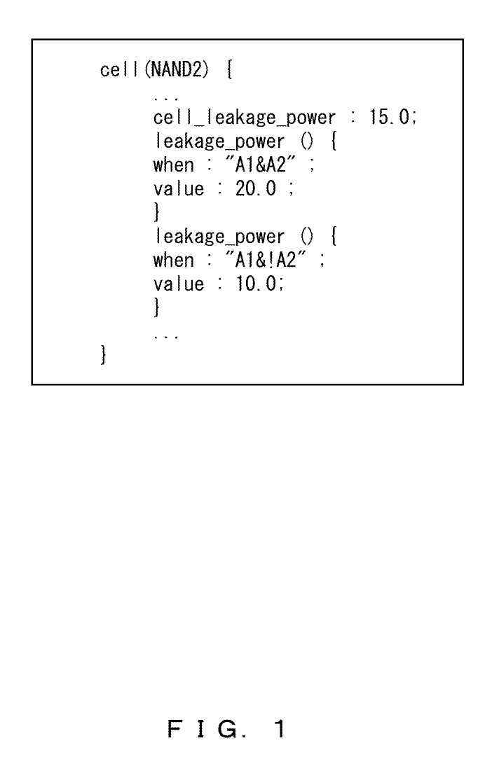

A leakage current value of a cell varies in accordance with input conditions (FIG. 1) as described above. In some cells, the internal states have influence on the leakage power. Because of this, the coefficients of Expression (1) are calculated for each input condition and each internal state. This is why simulation has to be executed for Expression (1) a number of times obtained by multiplying the minimum number of execution conditions with the number of input conditions and the number of internal states.

Meanwhile, dynamic power varies in accordance with variations in one input signal. Accordingly, Expression (3) is based on a relationship between one input signal and one output signal, i.e., a relationship between one input terminal and one output terminal of a cell (referred to as “input/output relationship” hereinafter).

In a cell with a plurality of output terminals, variations in one input signal may cause variations in a plurality of output signals. Variations in respective output signals are usually in accordance with the internal states of the cell and other input signals. Hereinafter, other signals input to a cell (signals input to other input terminals) are referred to as a “situation condition”. Also, a group of statuses that are discriminated for calculating the values of respective coefficients of expressions such as an input condition, input/output relationship, an internal state, and the like are referred to as a “logical state”.

In a cell with a plurality of output signals varying at the same time, one output signal as a target is divided by the following procedures. Herein, explanations are given on an assumption that n output signals vary at the same time.

First, a conditional variable that is not considered in Expression (3) and that has an influence on dynamic power is selected, one output signal that changes the value of the selected conditional variable is determined among output signals that vary at the same time, and the values of the respective coefficients of Expression (3) are calculated. In this calculation, the coefficients that are to be calculated are Cᵢₙₜ₁_{_{—}}ᵢ, Kₛᵢ₁_{_{—}}ᵢ, Kₛₒ₁_{_{—}}ᵢ, Kₛₓ₁_{_{—}}ᵢ, K_{c1}_{_{—}}ᵢ, Kₚ₁_{_{—}}ᵢ, Kᵥ₁_{_{—}}ᵢ, and Kₜ₁_{_{—}}ᵢ. These coefficients are also calculated similarly in respective different output signals that vary at the same time. The “i” at the tail of the subscript of each of the coefficients represents an integer between 1 and n. An example of a selected conditional variable is load capacity C_{load}. For the selected conditional variables, a maximum of five values can be used as described above.

After calculating the value of each coefficient of all output signals that vary at the same time, a fitting operation is performed on the following expression by using the calculated coefficients so as to calculate the values of coefficients Cint_all, Ksi2_i, and Ksox2_i (i=1, 2, . . . , n).

Q_{dyn}=Cᵢₙₜ_{_{—}}ₐₗₗ·V+ΣKₛᵢ₂_{_{—}}ᵢ·Tₛᵢₙ·(K_{c1}_{_{—1}}+exp(Kₚ₁_{_{—}}ᵢ·P_{chip}+Kᵥ₁_{_{—}}ᵢ·V+Kₜ₁_{_{—}}ᵢ/(Tⱼ+273)))+ΣKₛₒₓ₂_{_{—}}ᵢ·(Kₛₒ₁_{_{—}}ᵢ/Tₛₒᵤₜ_{_{—}}ᵢ+Kₛₓ₁_{_{—}}ᵢ·Tₛᵢₙ²/Tₛₒᵤₜ_{_{—}}ᵢ)·(K_{c1}_{_{—}}ᵢ+exp{Kₚ₁_{_{—}}ᵢ·P_{chip}+Kᵥ₁_{_{—}}ᵢ·V+Kₜ₁_{_{—}}ᵢ/(Tⱼ+273))) (5)

In the above expression Tₛₒᵤₜ_{_{—}}ᵢ is the output transition time of a selected output signal.

Expression (5) is obtained by expanding the second term at the right side of Expression (3) so that the overall influence of respective output signals is considered. Coefficients Kₛᵢ₂_{_{—}}ᵢ and Kₛₒₓ₂_{_{—}}ᵢ are used for adjusting the degrees of influence of the respective output signals. On the basis of Expression (5), the values of the respective coefficients of Expression (3) in one output signal associated with an input signal can be obtained as follows.

Cᵢₙₜ=Cᵢₙₜ_{_{—}}ₐₗₗ/n (6)

Kₛᵢ=Kₛᵢ₂_{_{—}}ᵢ (7)

Kₛₒ=Kₛₒₓ₂_{_{—}}ᵢ (8)

Kₛₓ=Kₛₒₓ₂_{_{—}}ᵢ·Kₛₓ₁_{_{—}}ᵢ (9)

K_{c}=K_{c1}_{_{—}}ᵢ (10)

Kₚ=Kₚ₁_{_{—}}ᵢ (11)

Kᵥ=Kᵥ₁_{_{—}}ᵢ (12)

Kₜ=Kₜ₁_{_{—}}ᵢ (13)

The coefficient library generation unit 44, when calculating the respective coefficients for dynamic power, refers to the results of simulation so as to determine whether or not a plurality of output signals vary in response to variations in signals in one input terminal specified by an input/output relationship that has been set. When it has been determined that a plurality of output signals vary, the values of the respective coefficients of Expression (3) are calculated by using Expressions (5) through (13). Thereby, a higher accuracy is achieved in evaluation.

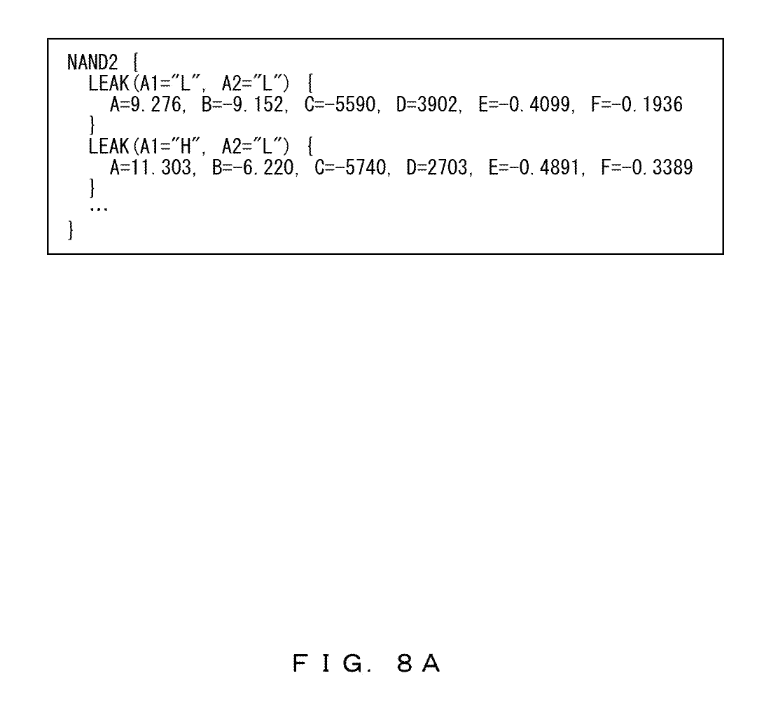

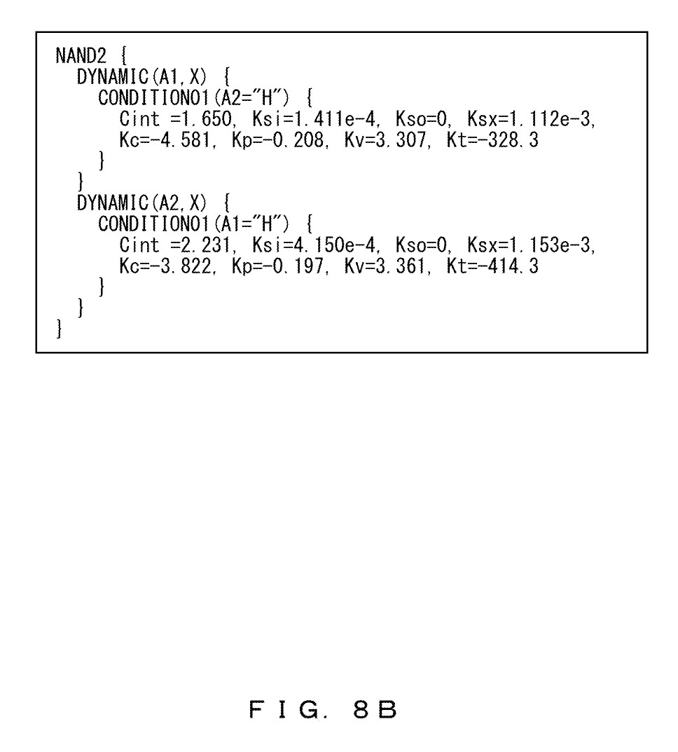

FIG. 8A illustrates an example of a description of leakage coefficient data, and FIG. 8B illustrates an example of a description of dynamic coefficient data. The description examples of FIG. 8A and FIG. 8B are both about a cell labeled “NAND2” (NAND gate). This cell “NAND2” includes two input terminals labeled “A1” and “A2”, and one output terminal labeled “X”.

The leakage power of the cell “NAND2” varies in accordance with the input conditions of signals, i.e., combinations of signals input to the respective input terminals. Accordingly, Expression (1) is used for each input condition (and/or each internal state). Thereby, leakage coefficient data is described for each input condition. “LEAK (A1=“L”, A2=“L”)” represents an input condition for signals of level L to be input to input terminals A1 and A2. “LEAK (A1=“H”, A2=“L”)” represents input conditions for a signal of level H to be input to input terminal A1 and for a signal of level L to be input to input terminal A2.

As described above, Expression (3) for calculating dynamic power is based on an input/output relationship between one input signal and one output signal. Thereby, dynamic coefficient data is described for each input/output relationship. In FIG. 8B, “DYNAMIC(A1,X)” represents the input/output relationship between input terminal A1 and output terminal X. “CONDITION01(A2=“H”)” in the curly brackets following the description of “DYNAMIC(A1,X)” represents a situation condition for a signal of level H (logical value=1) to be input to input terminal A2 while a signal input to input terminal A1 varies. Similarly, “DYNAMIC(A2,X)” represents an input/output relationship between input terminal A2 and output terminal X. “CONDITION01(A1=“H”)” in the curly brackets following “DYNAMIC(A2,X)” represent a situation condition for a signal of level H to be input to input terminal A1. Because a NAND gate is a combinational circuit, none of the situation conditions includes internal state.

As described above, leakage coefficient data and dynamic coefficient data of a cell are both generated for each logical state that is categorized by input conditions, input/output relationships, internal states, or the like. The coefficient library generation unit 44 executes a simulation under respective execution conditions represented by the coefficient library generation unit 44 for each logical state, and generates coefficient data, i.e., calculates the values of the respective coefficients. Thereby, leakage coefficient data and dynamic coefficient data as represented in FIG. 8A and FIG. 8B, respectively, are registered in the library 45a for each cell.

As described above, the library generation apparatus according to the present embodiment generates the library 45a. Coefficient data described in the library 45a only represents values of the respective coefficients for each logical state. This is for suppressing the entire data volume of the library 45a. In other words, this is because the same expressions are applied to all cells and thus the power consumption can be calculated by obtaining the value of the respective coefficients. When different expressions are applied to different cells, an expression including, for example, the values of the respective coefficients is described in the library 45a or identification data representing an expression to be applied is described in the library 45a. When different expressions are applied to different types of cells, it is possible to describe only the values of the respective coefficients for each logical state.

The library 45a including a description of coefficient data for each cell as described above can be used for evaluating the power consumption within the range of the PVT conditions represented by the evaluation range information 41a (including the ranges of the values of a plurality of conditional variables in this example). Accordingly, it is not necessary to prepare many libraries 45a. The number of the libraries 45a can be greatly reduced with respect to a case where libraries that define derating factors are prepared. The data volume of one library 45a does not increase greatly in comparison with the conventional techniques. Accordingly, it is possible to respond to a wide range of PVT conditions while greatly suppressing the memory volume needed for storing libraries in comparison with the conventional techniques.

Next, explanations will be given for a power consumption calculation apparatus according to the present embodiment.

A power consumption calculation apparatus according to the present embodiment includes a condition obtainment unit 46, an instance-by-instance power consumption calculation unit 47, and an LSI power consumption calculation unit 48.

The condition obtainment unit 46 obtains a PVT condition 46a to be used for evaluating power consumption. In a practical configuration, the condition obtainment unit 46 is an input device that prompts a user (operator) to specify the PVT condition 46a. The instance-by-instance power consumption calculation unit 47 calculates power consumption for each cell (instance) as a constituent component of a semiconductor device (referred to as an “LSI” hereinafter) as a target of power consumption evaluation. Power consumption varies in accordance with PVT conditions. Accordingly, power consumption is calculated with reference to the libraries 45a and the PVT conditions 46a input from the condition obtainment unit 46. Hereinafter, “46a” will only be used to denote PVT conditions that are used for calculation of power consumption so that such PVT conditions are discriminated from other PVT conditions.

Power consumption, i.e., a leakage power value and a dynamic power value, varies in accordance with values of conditional variables. The values of conditional variables are given independently from the PVT condition 46a. In the present embodiment, the PVT condition 46a represents process variation P_{chip}, power-supply voltage V, and junction temperature T. Process variation P_{ocv} is not included in the PVT condition 46a. This is because the average value of a plurality of leakage current values Iₗₑₐₖ obtained from Expression (1) with different values of process variation P_{ocv} is used on an assumption that leakage current value Iₗₑₐₖ would conform to the normal distribution with an average of zero and a standard deviation of one. The average value of leakage current values Iₗₑₐₖ is referred to as “average leakage current value Iₗₑₐₖₐ” hereinafter. Process variation P_{ocv} may be included in the PVT condition 46a.

Leakage power values and dynamic power values vary in accordance with logical states of a cell. Accordingly, a logical state is set for each instance. Thereby, the instance-by-instance power consumption calculation unit 47 calculates the power consumption value in a set logical state for each instance.

Methods of setting logical states for each instance are not particularly limited. Logical states can be set by executing logical simulation. There is also a method in which logical states are set at random, a method in which logical states are set statistically, and other methods. As a statistical method, a method is possible in which logical conditions that can be set for, for example, each cell are determined, the probability that the logic states will be realized is evaluated for each of the determined logic states, and the logical states are assigned to respective cells (instances) in accordance with the evaluated probability. Input transition time Tₛᵢₙ and output transition time Tₛₒᵤₜ may be set by using the results of, for example, STA (Static Timing Analysis), which is used for verifying timings.

Specific explanations will be given for calculation accuracy in each expression used for calculating the values of the respective coefficients as described above by referring to FIG. 8A through FIG. 14E.

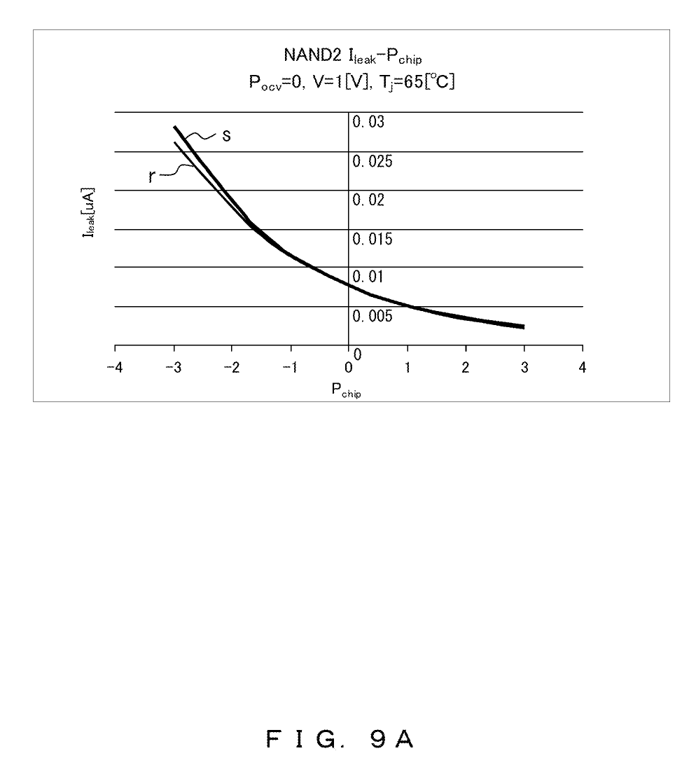

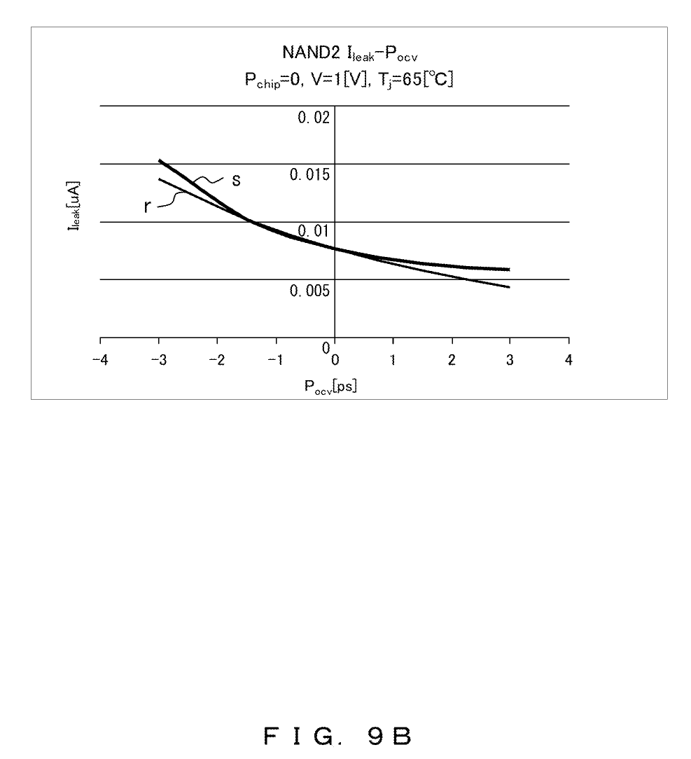

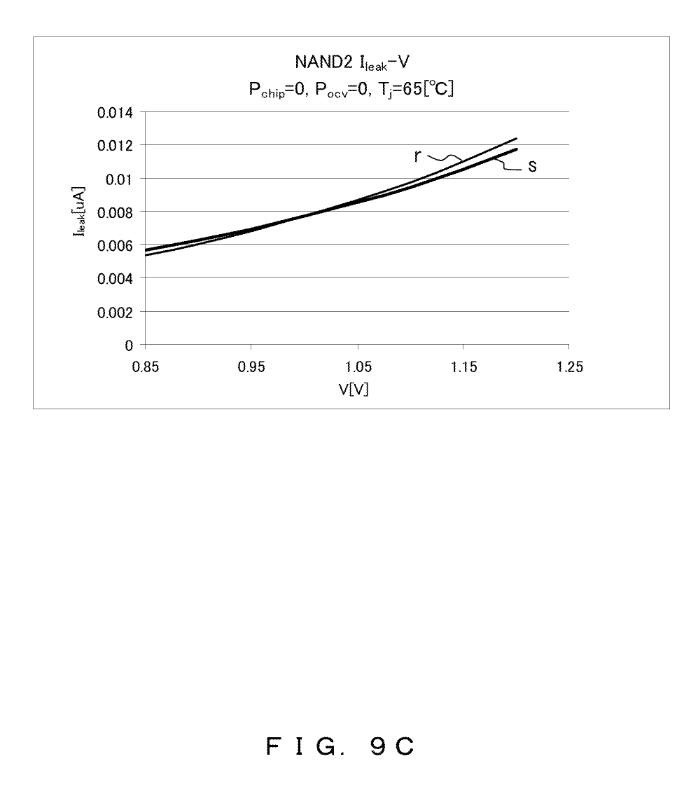

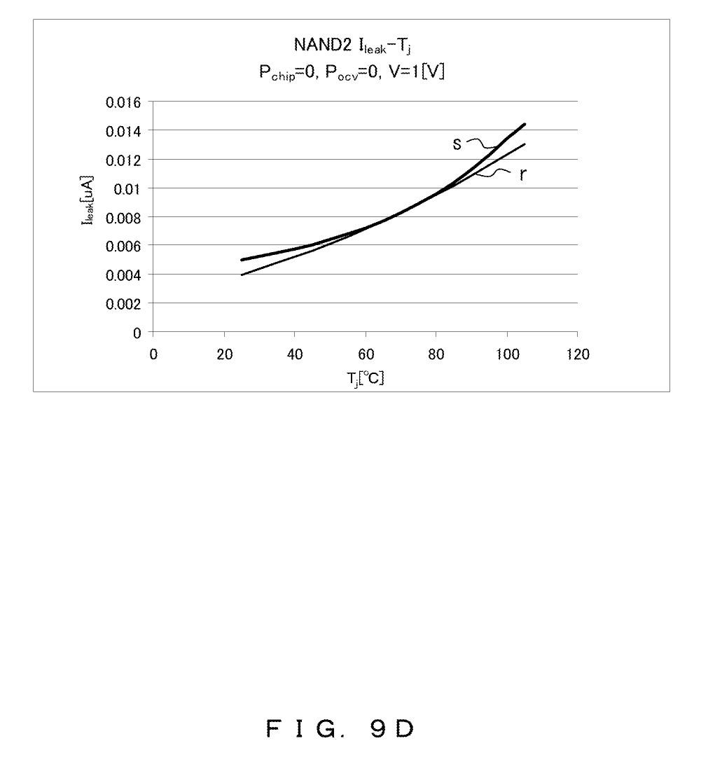

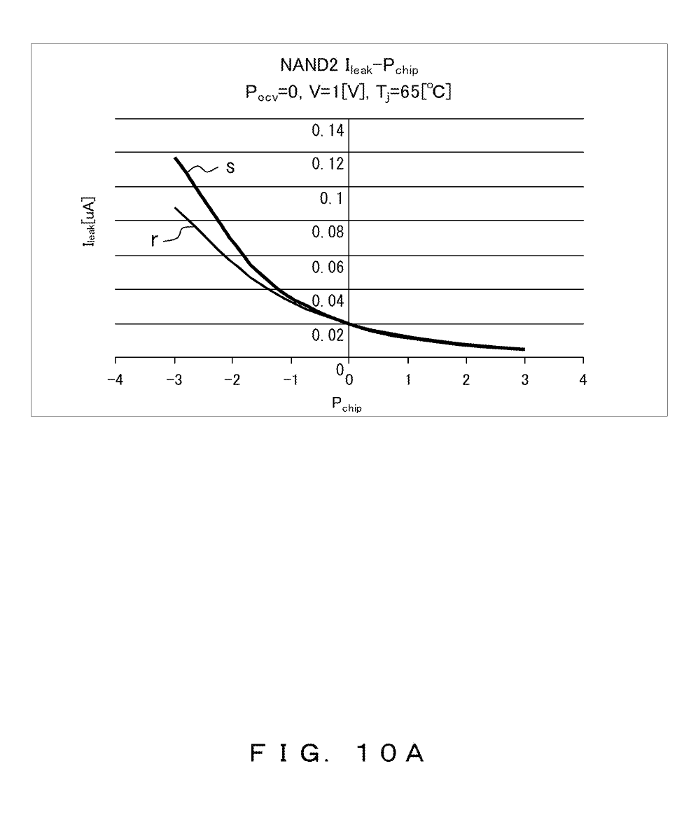

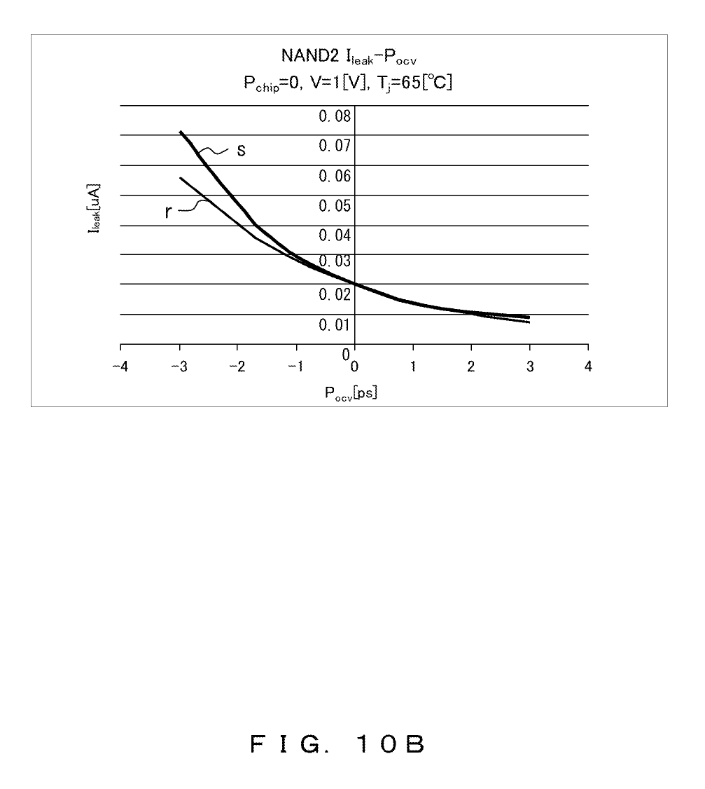

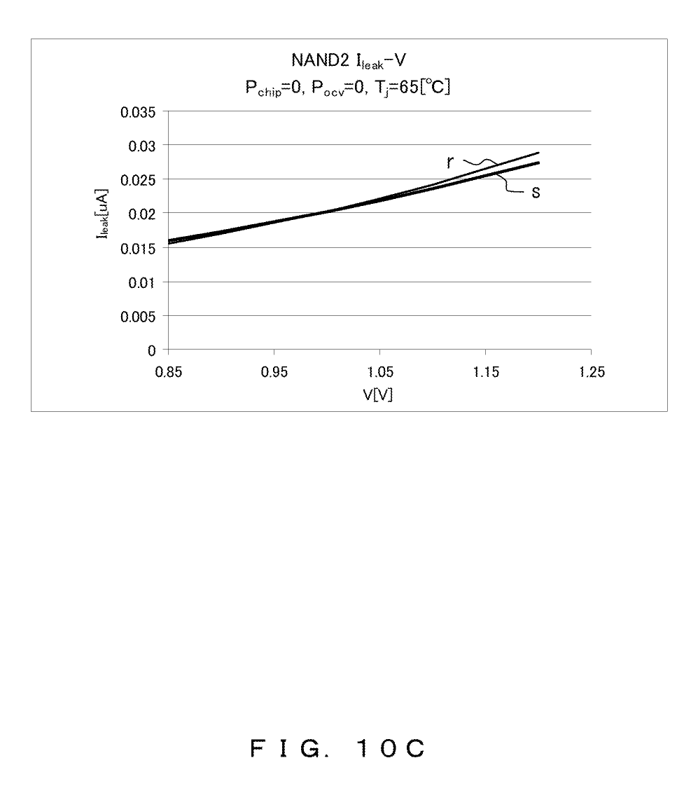

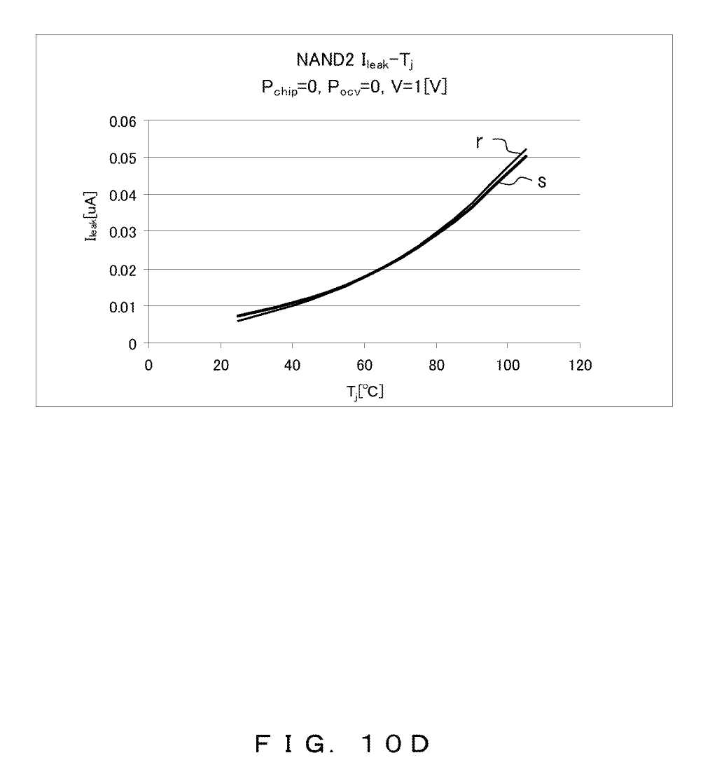

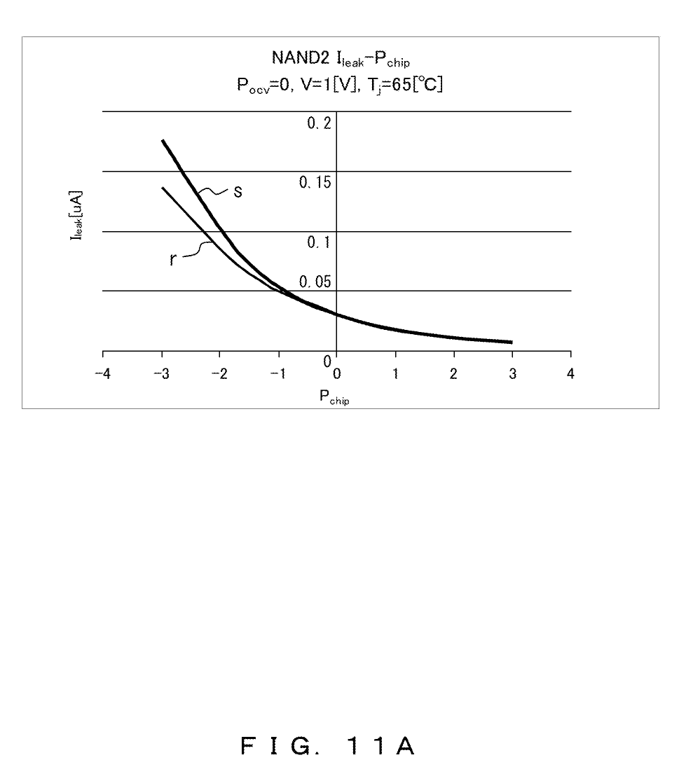

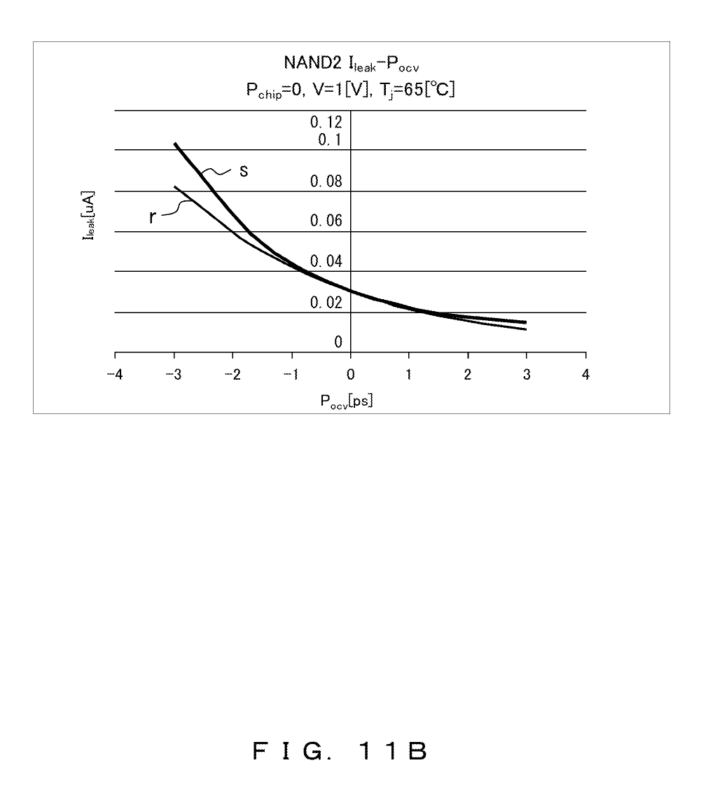

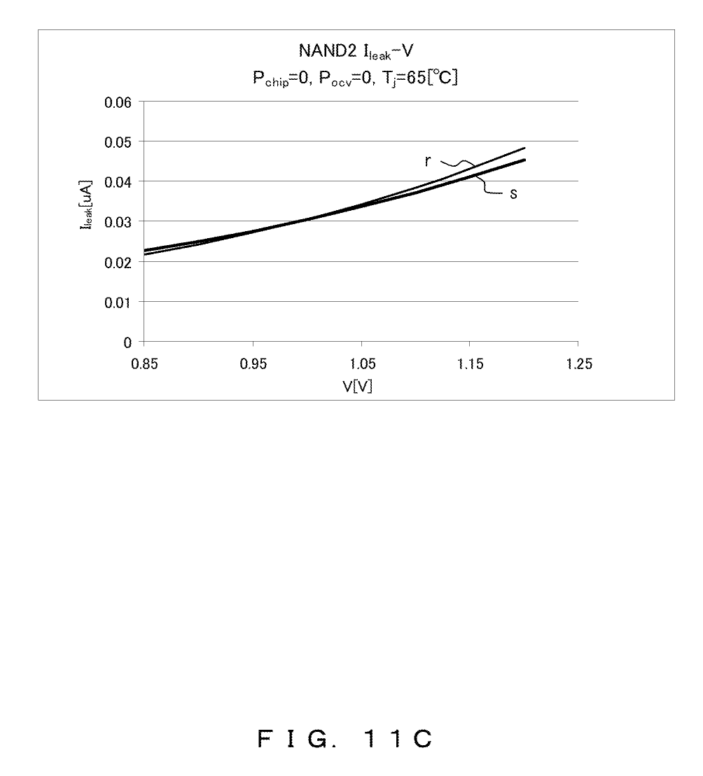

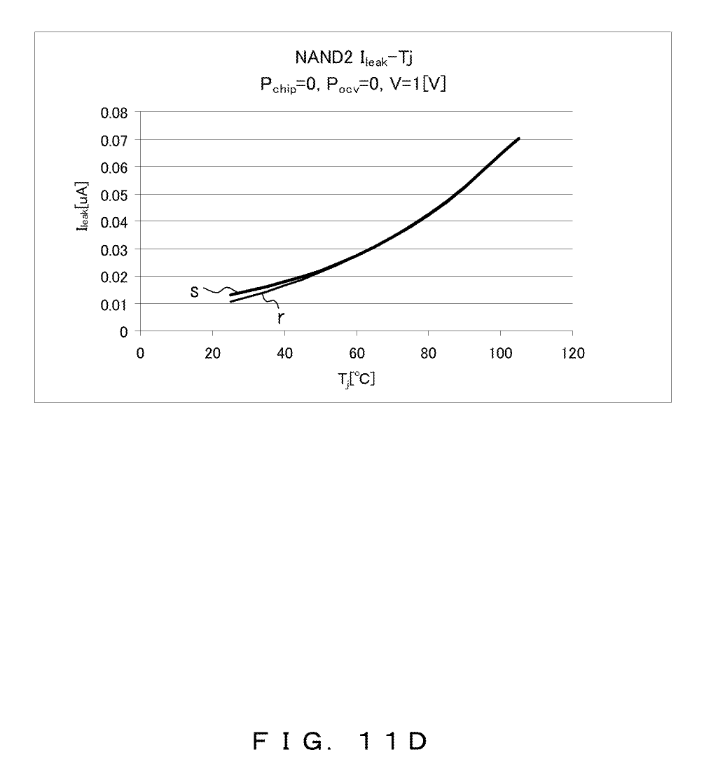

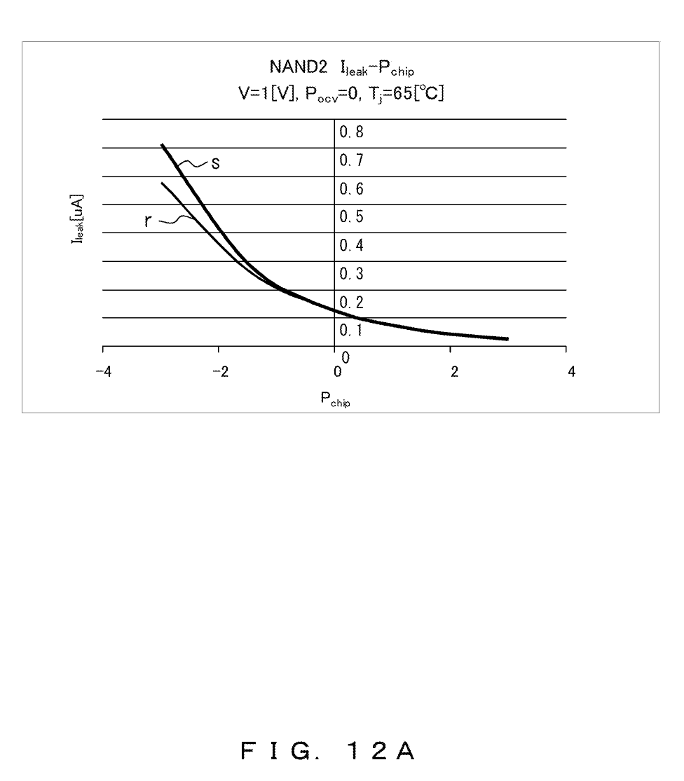

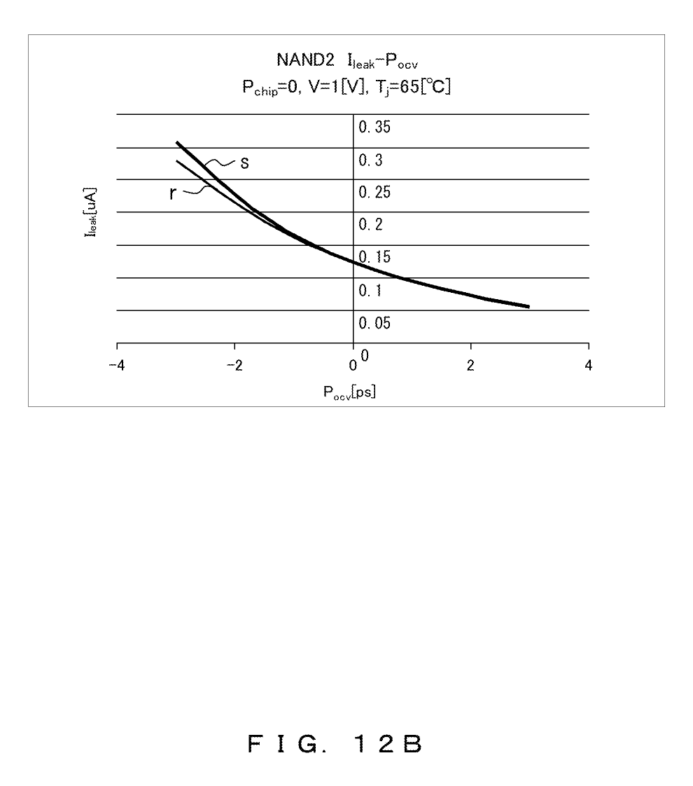

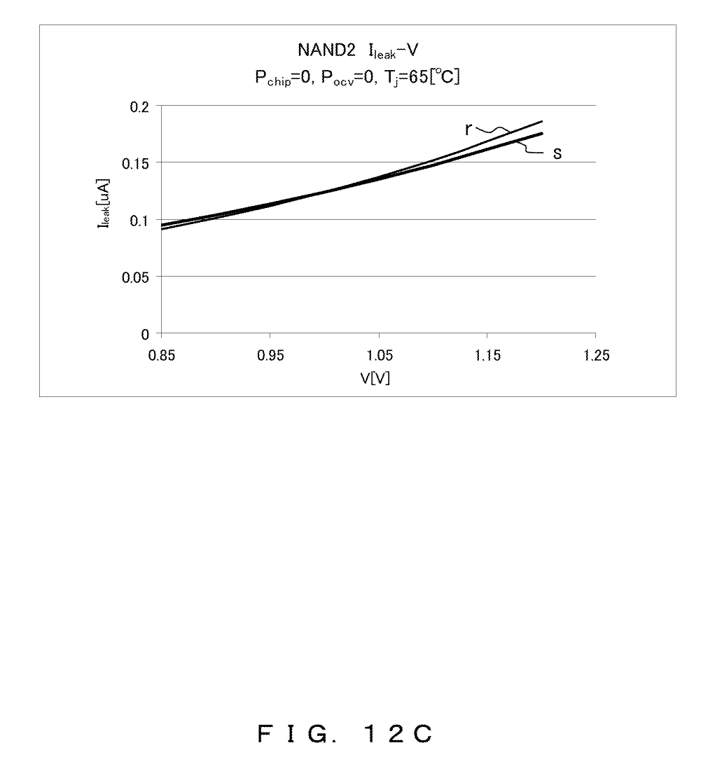

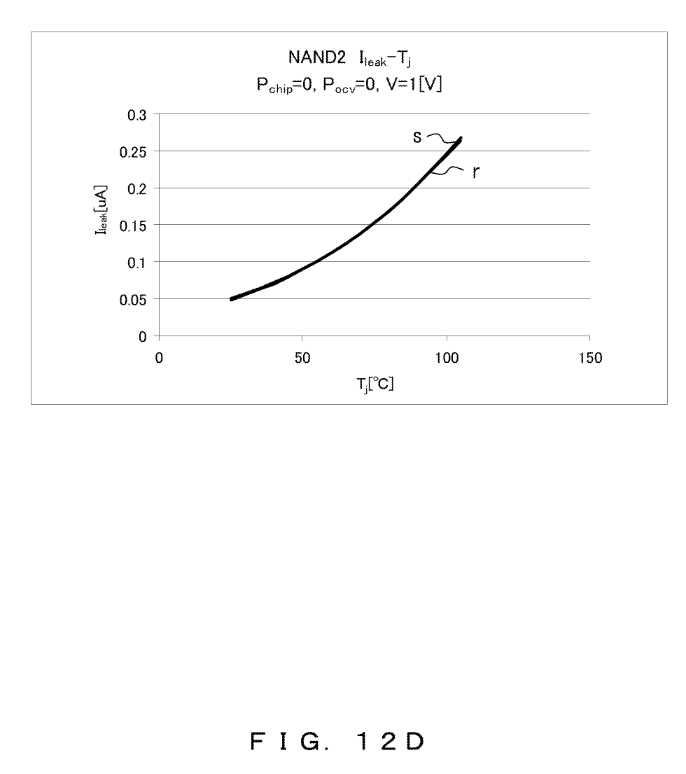

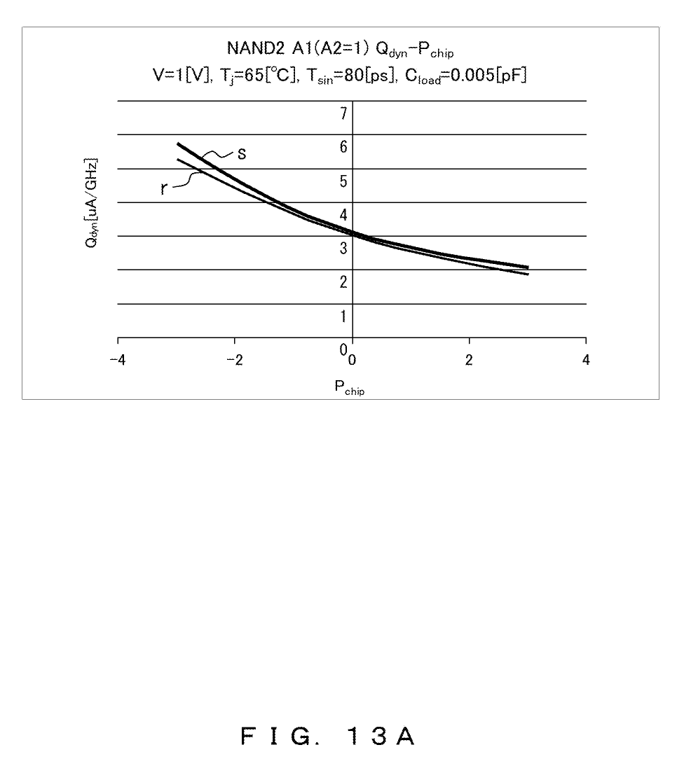

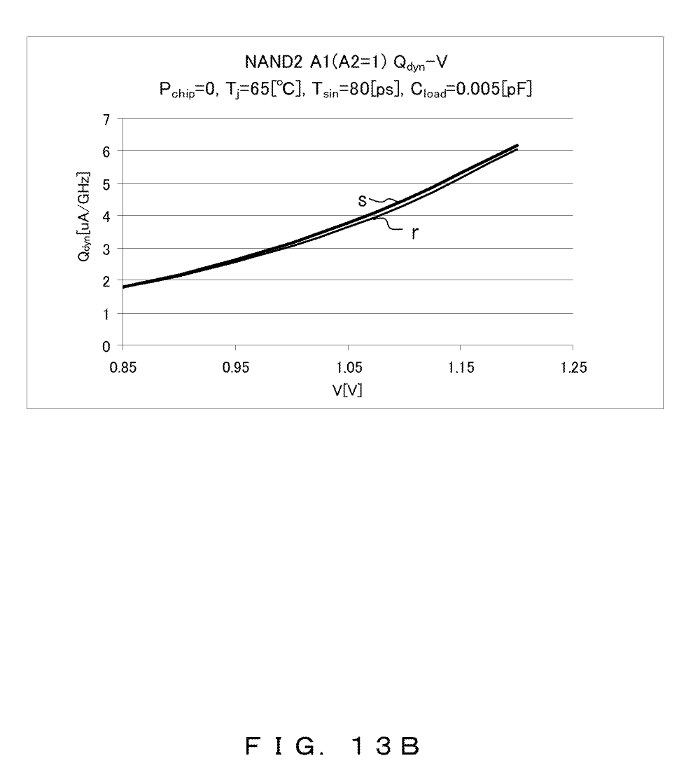

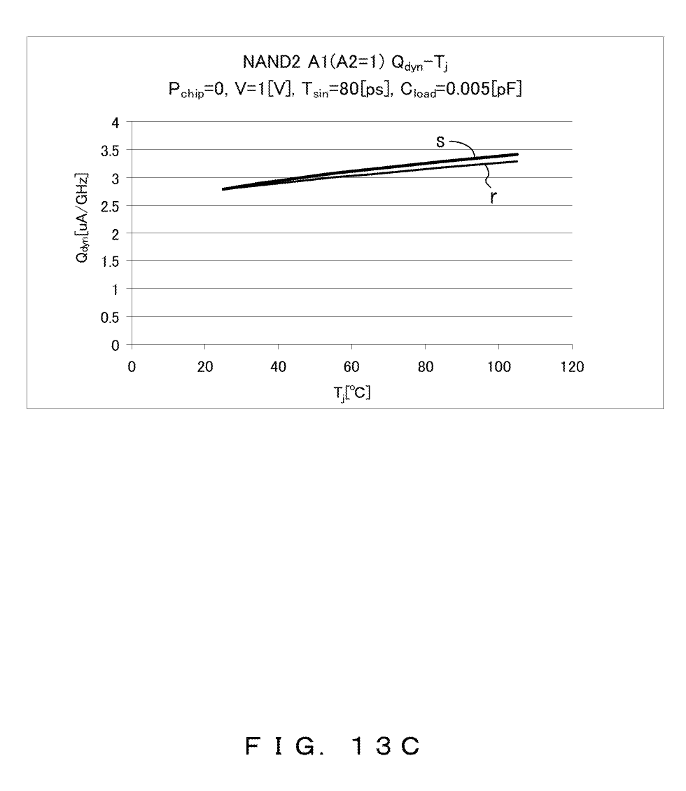

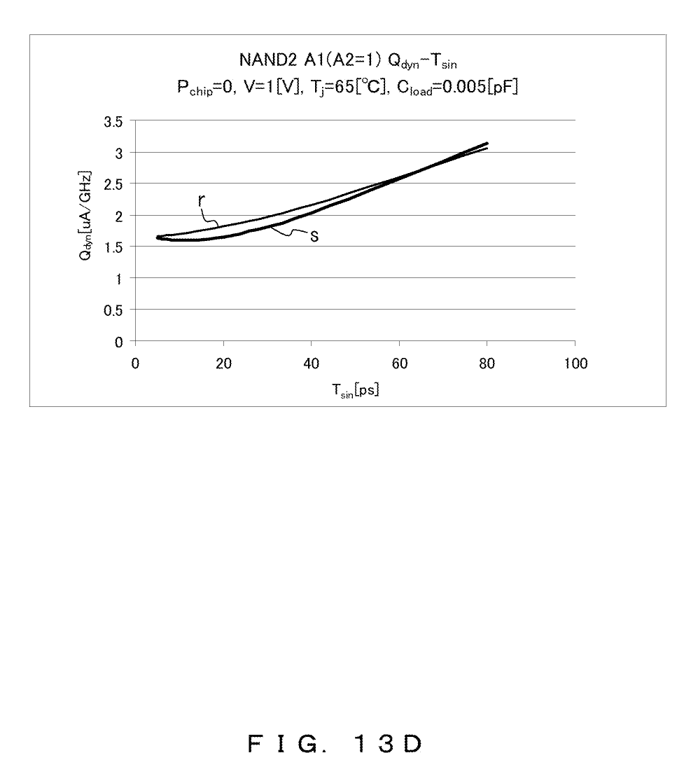

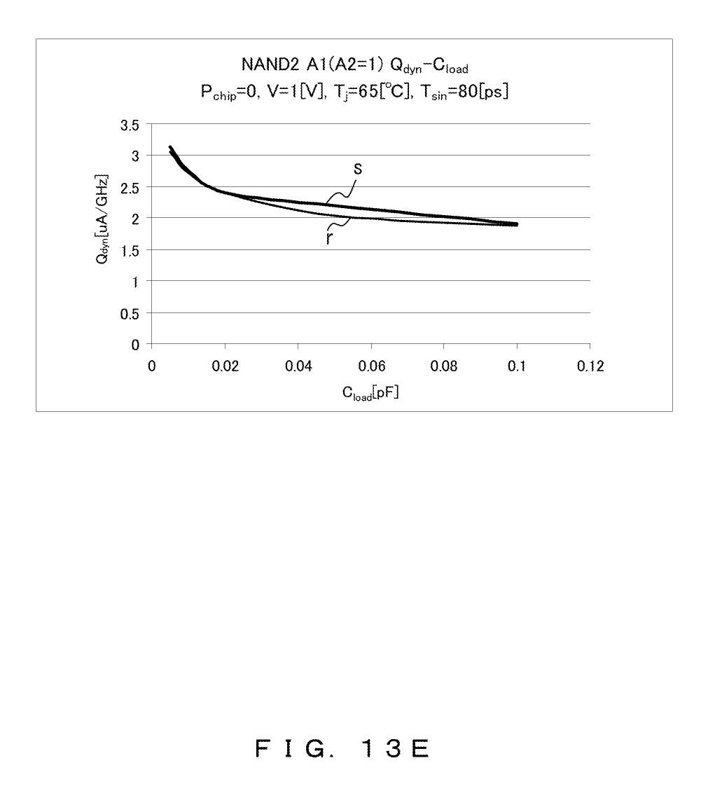

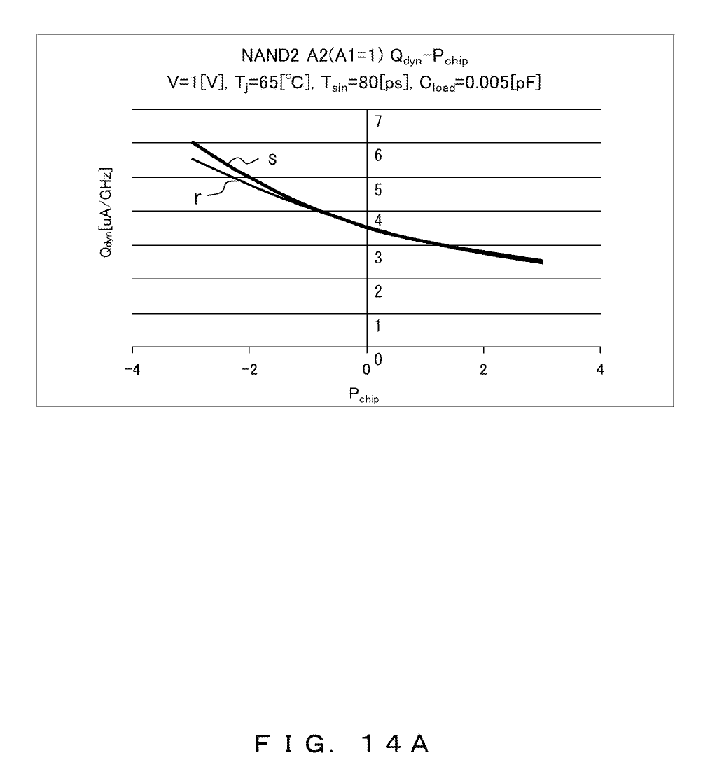

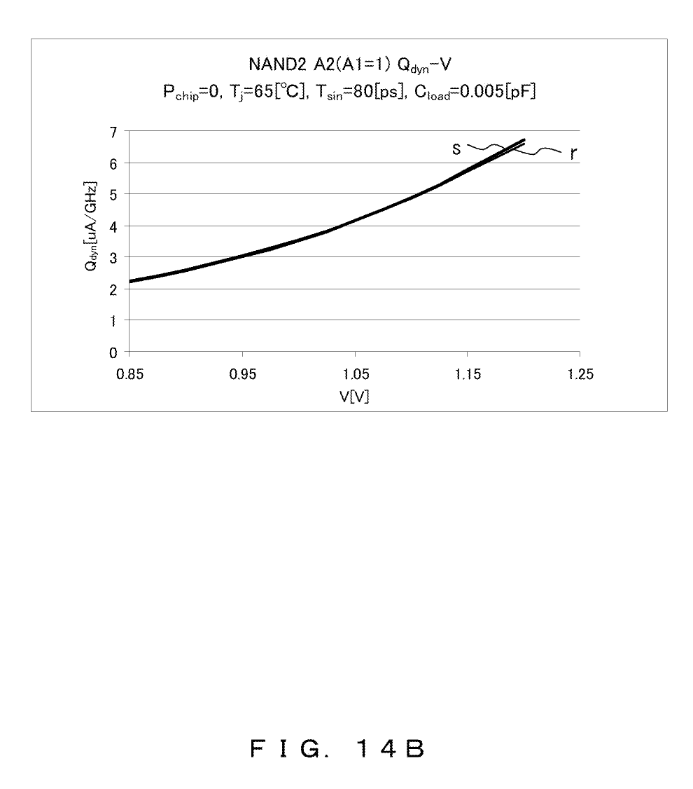

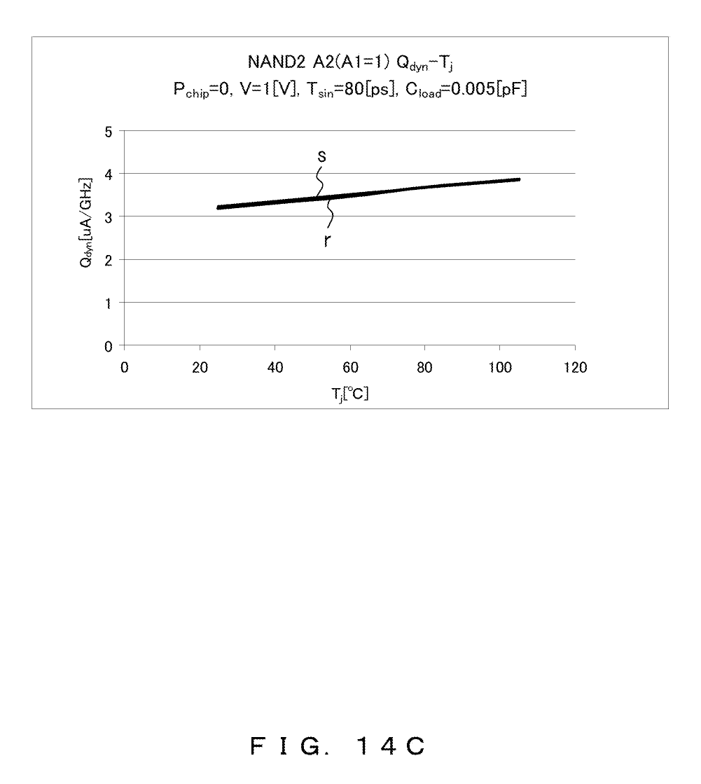

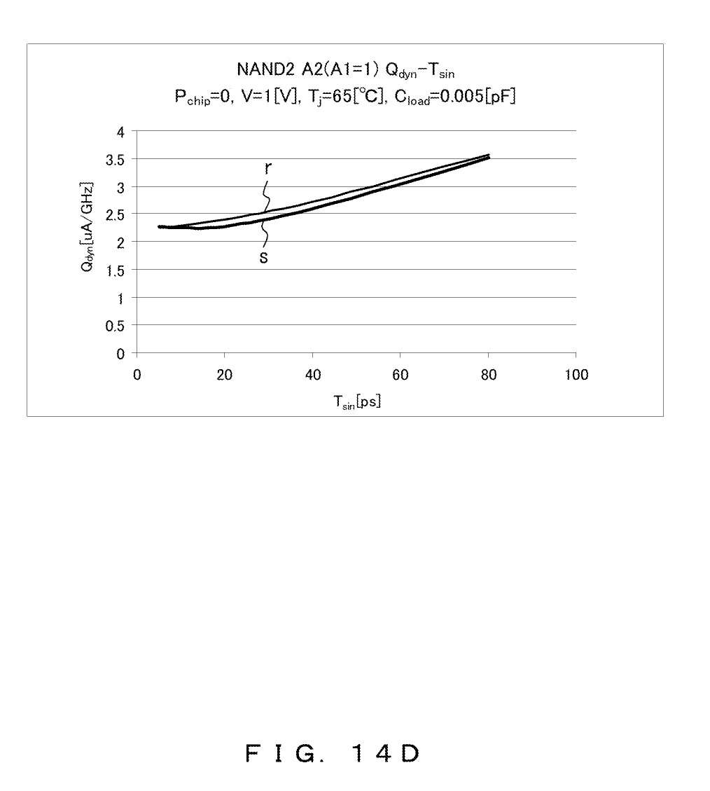

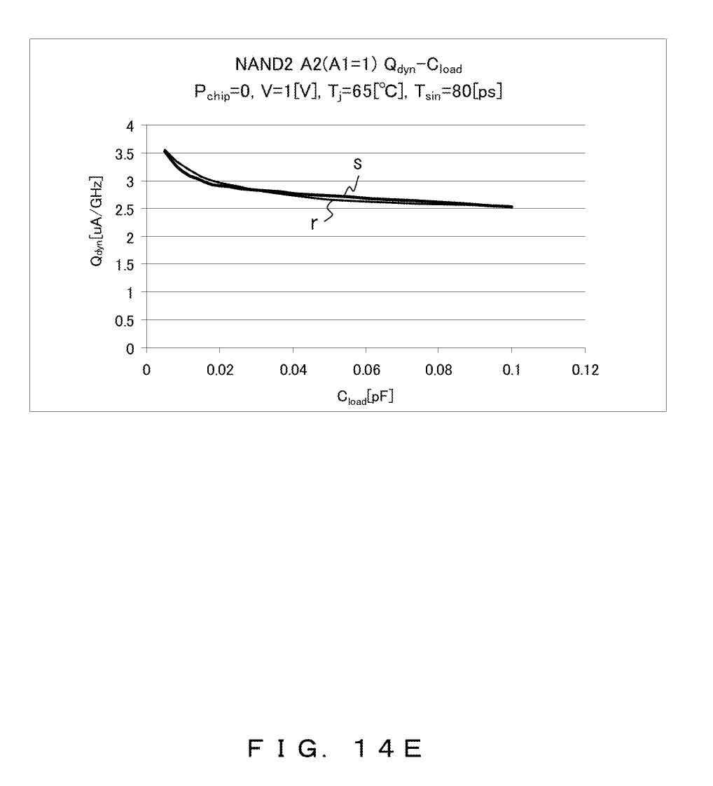

FIG. 9A through FIG. 9D, FIG. 10A through FIG. 10D, FIG. 11A through FIG. 11D, and FIG. 12A through FIG. 12D are graphs illustrating variations in leakage current values Iₗₑₐₖ, caused by PVT conditions, that are calculated by Expression (1); FIG. 13a through FIG. 13E and FIG. 14A through FIG. 14E are graphs illustrating variations, caused by PVT conditions of consumed charge quantity Q_{dyn} or other conditional variables, that are calculated by Expression (3). The respective graphs are about a cell labeled “NAND2” (NAND gate), and also illustrate results of simulation for comparison. Lines denoted by “s” represent results of simulation, and lines denoted by “r” represent results of calculation.

FIG. 9A is a graph illustrating a variation in leakage current value Iₗₑₐₖ (μA) caused by the value of process variation P_{chip} under the conditions that the value of P_{ocv} is zero, power-supply voltage V is 1V, and junction temperature Tⱼ is 65° C. The vertical axis represents leakage current value Iₗₑₐₖ, and the horizontal axis represents process variation P_{ocv}. FIG. 9B illustrates a variation in leakage current value Iₗₑₐₖ caused by process variation P_{ocv} under the conditions that the value of process variation P_{chip} is zero, the power-supply voltage V is 1V, and junction temperature Tⱼ is 65° C. The vertical axis represents leakage current value Iₗₑₐₖ, and the horizontal axis represents process variation P_{chip}. FIG. 9C illustrates a variation in leakage current value Iₗₑₐₖ caused by power-supply voltage V under the conditions that the values of process variations P_{chip} and P_{ocv} are zero and the junction temperature Tⱼ is 65° C. The vertical axis represents a leakage current value Iₗₑₐₖ, and the horizontal axis represents a power-supply voltage V. FIG. 9D illustrates a variation in leakage current value Iₗₑₐₖ caused by junction temperature Tⱼ under the conditions that the values of process variations P_{chip} and P_{ocv} are zero and the power-supply voltage V is 1V. The vertical axis represents leakage current value Iₗₑₐₖ, and the horizontal axis represents junction temperature Tⱼ.

Conditions for meeting the graphs of FIG. 9A through FIG. 9D also apply to those of FIG. 10A through FIG. 10D, FIG. 11a through FIG. 11d, and FIG. 12A through FIG. 12d. What are different between FIG. 9A through FIG. 9D, FIG. 10A through FIG. 10D, FIG. 11a through FIG. 11d, and FIG. 12A and FIG. 12d are input conditions, i.e., combinations of signals to be input to input terminals A1 and A2. Those input conditions are that the signal level for input terminal A1 is Hand the signal level for input terminal A2 is L in FIG. 9a through FIG. 9D, the signal level for input terminal A1 is L and the signal level for A2 is H in FIG. 10A through FIG. 10D, signal levels for A1 and A2 are both L in FIG. 11a through FIG. 11d, and the signal level for A1 and A2 are both H in FIG. 12A through FIG. 12D.

As is obvious from FIG. 9A through FIG. 9D, FIG. 10A through FIG. 10D, FIG. 11A through FIG. 11D, and FIG. 12A and FIG. 12D, Expression (1) is capable of calculating leakage current value Iₗₑₐₖ with a high accuracy under different PVT conditions and input conditions. In the graph in FIG. 10A, the difference between simulation result s and calculation result r is relatively large in a region where P_{chip} has small values. However, there is actually only a small need to take that region into consideration for calculating power consumption thanks to the calculation method using the process variation P_{chip} (FIG. 7). Because of this as well, errors in that region have a very small influence on the accuracy in evaluating power consumption.

The graphs in FIG. 13A through FIG. 13E illustrate cases where signals input to input terminal A1 vary, with the level of signals input to input terminal A2 being H. The graphs in FIG. 14a through FIG. 14E illustrate cases where signals input to input terminal A2 vary, with the level of signals input to input terminal A1 being H.

The graphs in FIG. 13A and FIG. 14A illustrate variations in consumed charge quantity Q_{dyn} caused by the value of process variation P_{chip} under the conditions that power-supply voltage V is 1V, junction temperature Tⱼ is 65° C., Tₛᵢₙ is 80 ps, and load capacity C_{load} is 0.005 pF. The vertical axes represent consumed charge quantity Q_{dyn}, and the horizontal axes represent process variation P_{chip}. The graphs in FIG. 13B and FIG. 14B represent variations in consumed charge quantity Q_{dyn} caused by power-supply voltage V under the conditions that process variation P_{chip} is zero, junction temperature Tⱼ is 65° C., input transition time Tₛᵢₙ is 80 ps, and load capacity C_{load} is 0.005 pF. The vertical axes represent consumed charge quantity Q_{dyn}, and the horizontal axes represent power-supply voltage V. The graphs in FIG. 13c and FIG. 14c represent variations in consumed charge quantity Q_{dyn} caused by junction temperature Tⱼ under the conditions that the value of process variation P_{chip} is zero, power-supply voltage V is 1V, input transition time Tₛᵢₙ is 80 ps, load capacity C_{load} is 0.005 pF. The vertical axes represent consumed charge quantity Q_{dyn}, and the horizontal axes represent junction temperature T. Graphs in FIG. 13D and FIG. 14D represent variations in consumed charge quantity Q_{dyn} caused by input transition time Tₛᵢₙ, under the conditions that the value of process variation P_{chip} is zero, power-supply voltage V is 1V, junction temperature Tⱼ is 65° C., and load capacity C_{load} is 0.005 pF. The vertical axes represent consumed charge quantity Q_{dyn}, and the horizontal axes represent input transition time Tₛᵢₙ. The graphs in FIG. 13E and FIG. 14E represent variations in consumed charge quantity Q_{dyn} caused by load capacity C_{load} under the conditions that the value of process variation P_{chip} is zero, power-supply voltage V is 1V, junction temperature Tⱼ is 65° C., and input transition time Tₛᵢₙ is 80 ps. The vertical axes represent consumed charge quantity Q_{dyn}, and the horizontal axes represent load capacity C_{load}. Therefore, the graphs in FIG. 13A through FIG. 13E and FIG. 14A through FIG. 14E take input transition time Tₛᵢₙ and load capacity C_{load} into consideration as conditional variables.

As is obvious from FIG. 13A through FIG. 13E and FIG. 14A through FIG. 14E, Expression (3) is capable of calculating consumed charge quantity Q_{dyn} with a high accuracy under different PVT conditions and conditional variables. Similarly to Expression (1), in the graphs in FIG. 13A and FIG. 14A, the difference between simulation result s and calculation result r is relatively large in a region where P_{chip} has small values. However, errors in that region have a very small influence on the accuracy in evaluating power consumption for the same reason as in the case of Expression (1).

Accordingly, the instance-by-instance power consumption calculation unit 47 is capable of highly accurately calculating leakage current value Iₗₑₐₖ and consumed charge quantity Q_{dyn} (dynamic current value I_{dyn}) in logical states in which respective instances are set. The instance-by-instance power consumption calculation unit 47 calculates leakage current value Iₗₑₐₖ and consumed charge quantity Q_{dyn}, and calculates the power consumption value of the entire instance by using the calculated Iₗₑₐₖ and Q_{dyn}. The power consumption value of the entire instance is output to the LSI power consumption calculation unit 48. A power consumption value of the entire instance will be referred to as “Pᵢₙₛₜ” hereinafter so that it is discriminated from other power consumption values.

The LSI power consumption calculation unit 48 accumulates power consumption value Pᵢₙₛₜ for each instance input from the instance-by-instance power consumption calculation unit 47 so as to calculate the power consumption value 49 of the entire LSI. As was described above, leakage current value Iₗₑₐₖ and consumed charge quantity Q_{dyn} (dynamic current value I_{dyn}) can be calculated for each instance with a high accuracy. Accordingly, the power consumption value 49, which is calculated as the final calculation, is also highly accurate.

The condition obtainment unit 46, the generation condition determination unit 42, the coefficient library generation unit 44, the instance-by-instance power consumption calculation unit 47, and the LSI power consumption calculation unit 48 illustrated in FIG. 4 operate as described above. The configuration illustrated in FIG. 4, i.e., a power consumption calculation apparatus according to the present embodiment, is implemented by causing a computer (data processing apparatus) to execute a program according to the present embodiment.

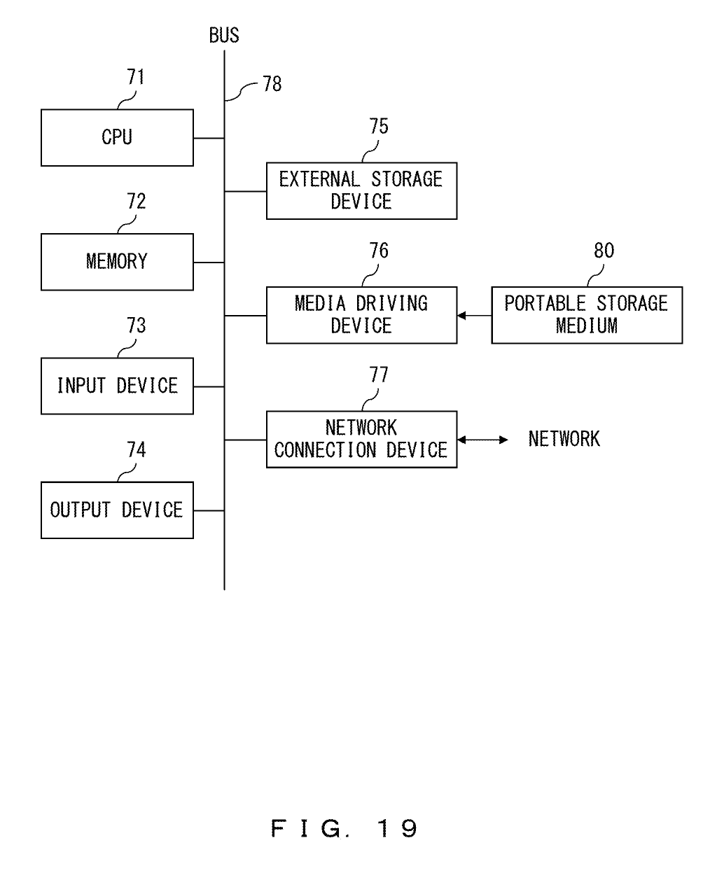

FIG. 19 illustrates an example of a hardware configuration of a computer to which the present embodiment can be applied. Specific explanations will be given for an example of a configuration of a computer that can be used as a power consumption calculation apparatus by referring to FIG. 19.

A program according to the present embodiment (referred to as a “power consumption evaluation program” hereinafter) includes, for example, a sub program that implements the library generation apparatus according to the present embodiment (referred to as a “library generation program” hereinafter) and a sub program that implements a power consumption calculation apparatus according to the present embodiment (referred to as a “power consumption calculation program” hereinafter). The library generation apparatus and the power consumption calculation apparatus according to the present embodiment are implemented by causing a computer to execute the corresponding sub programs.

The computer whose configuration is illustrated in FIG. 19 includes a CPU 71, a memory 72, an input device 73, an output device 74, an external storage device 75, a media driving device 76, and a network connection device 77, and they are connected to each other through a bus 79. The configuration illustrated in FIG. 19 is an example, and the scope of the present invention is not limited to this example.

The CPU 71 controls the entire computer. Although FIG. 19 illustrates only one CPU, a plurality of CPUs may be included.

The memory 72 is a semiconductor memory such as RAM or the like that temporarily stores a program or data stored in the external storage device 75 (or a portable storage medium 80) when the program is executed, the data is updated, or in other cases. The CPU 71 reads the program to the memory 72 so as to execute the program, and controls the entire computer.

The input device 73 is a device that includes an operation device such as a keyboard to be used by an operator and a device including a detection device that detects operations made on the operation device, or is an interface for connections with a different computer functioning as a terminal device (for example, a console). In the former case, the input device 73 detects operations made by an operator on the operation device so as to report the detection result to the CPU 71. In the latter case, the input device 73 receives instructions from an operator through the terminal device so as to report the instructions to the CPU 71. It is herein assumed for simplicity that the former device is the input device 73.

The output device 74 includes, for example, a display device and a display control device connected to the display device. The library generation condition 43a, the library 45a, and the power consumption value 49 illustrated in FIG. 4 can be displayed on the display device of the instance-by-instance power consumption calculation unit 47. The external storage device 75 is a large capacity storage device such as, for example, a flash memory, a hard disk, or the like. External storage device 75 is mainly used for storing various types of data and programs.

The media driving device 76 accesses the portable storage medium 80 such as a memory card or the like. The network connection device 77 enables communications with external devices (not illustrated) through, for example, a communication network. Execution of simulation or calculation of power consumption requires the design data of a semiconductor device (LSI) (for example, a net list that describes connection states between cells) and detailed data of each cell (data for simulation). When such data is stored in an external device, the network connection device 77 is used for obtaining that data.

A power consumption evaluation program is recorded in the external storage device 75 or the portable storage medium 80, or is obtained by using the network connection device 77 through a communication network. A library generation apparatus and a power consumption calculation apparatus according to the present embodiment can be implemented by reading the power consumption evaluation program to the memory 72 so that the CPU 71 executes it.

In the configuration illustrated in FIG. 19, the information obtainment unit 41, the generation condition determination unit 42, the coefficient library generation unit 44, the instance-by-instance power consumption calculation unit 47, and the LSI power consumption calculation unit 48 illustrated in FIG. 4 are implemented by the following combinations. It is herein assumed that a power consumption evaluation program is stored in the external storage device 75 and that generated data is stored in external storage device 75 for simplicity. It is also assumed that data of an LSI (semiconductor device) as a power consumption evaluation target and other data necessary for power consumption evaluation such as detailed data of each cell or the like necessary for execution of simulation have all been stored in the external storage device 75.

On this assumption, the information obtainment unit 41, the generation condition determination unit 42, and the instance-by-instance power consumption calculation unit 47 are implemented by, for example, the CPU 71, the memory 72, the input device 73, the external storage device 75, and the bus 79. The coefficient library generation unit 44 and the LSI power consumption calculation unit 48 are implemented by, for example, the CPU 71, the memory 72, the external storage device 75, and the bus 79. The first storage unit 43 and the second storage unit 45 are, for example, the external storage devices 75.

In addition to the activation of a library generation program, the input device 73 is used for inputting or specifying the evaluation range information 41a in order to generate a library. The input device 73 is also used for specifying an LSI for which a library is to be generated (for example, for specifying a net list), for giving an instruction to generate the library 45a, and for performing other operations. In response to that instruction to generate a library, the generation condition determination unit 42 for example generates the library generation condition 43a, and the coefficient library generation unit 44 automatically generates the library 45a in accordance with the generated library generation condition 43a. Accordingly, the input device 73 is a constituent that implements the information obtainment unit 41 and the generation condition determination unit 42, but is not a constituent that implements the coefficient library generation unit 44.

In calculation of the power consumption value 49, the input device 73 is used for inputting or specifying the PVT condition 46a in addition to the activation of the power consumption calculation program. The input device 73 is also used for specifying an LSI whose power consumption value 49 is to be calculated (for example, for specifying a net list), for specifying various factors such as the library 45a and the PVT condition 46a, and for giving various instructions such as an instruction to calculate the power consumption value 49. In response to that instruction to calculate the value, the instance-by-instance power consumption calculation unit 47 calculates power consumption value Pᵢₙₛₜ of each instance of a cell specified by using the library 45a specified under the specified PVT condition 46a. The LSI power consumption calculation unit 48 automatically calculates the power consumption value 49 by using, for example, Pᵢₙₛₜ of each instance.

Accordingly, the input device 73 is a constituent that implements the condition obtainment unit 46 and the instance-by-instance power consumption calculation unit 47, but is not a constituent that implements the LSI power consumption calculation unit 48. When a storage destination, an output destination, or the like of the calculated power consumption value 49 can be specified by operating the input device 73, the input device 73 as well is a constituent that implements the LSI power consumption calculation unit 48.

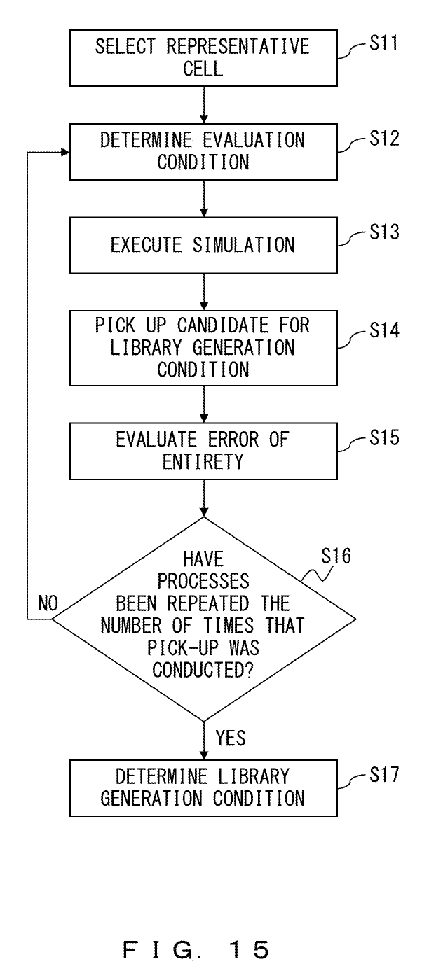

The power consumption evaluation program causes a computer to execute the following processes so as to implement the information obtainment unit 41, the generation condition determination unit 42, the coefficient library generation unit 44, the instance-by-instance power consumption calculation unit 47, and the LSI power consumption calculation unit 48. Next, specific explanations will be given for respective processes executed by a computer in accordance with the power consumption evaluation program, by referring to the flowcharts illustrated in FIG. 15 through FIG. 18.

FIG. 15 is a flowchart for a library generation condition determination process. First, detailed explanations will be given for a library generation condition determination process by referring to FIG. 15. This library generation condition determination process is executed for generating the library generation condition 43a. FIG. 15 illustrates a portion that is executed in response to a generation instruction of the library 45a after, for example, an LSI for which a library is to be generated (for example, a net list) has been specified. The generation condition determination unit 42 is implemented by execution of the library generation condition determination process by a computer (the CPU 71 in the computer).

First, in step S11, a computer obtains the evaluation range information 41a that has been input to the input device 73 through operations by an operator or that has been specified in the input device 73 through operations by an operator, and selects a plurality of cells as evaluation targets for determining the library generation condition 43a. The selection of cells is conducted by referring to a specified LSI (for example, a net list) or other libraries of the cells. In subsequent step S12, the computer determines, for each conditional variable, a step width from the value range represented by the obtained evaluation range information 41a so as to determine combinations of the values of the respective conditional variables. Thereafter, the process proceeds to step S13, where the computer executes simulation for obtaining the consumed current of each of the selected cells. Simulation of each cell is executed for each expression and each combination of the values of the respective conditional variables. A plurality of logical states may be prepared for one cell, while a single logical state may also be prepared for one cell. After executing all types of simulation, the process proceeds to step S64.

In step S14, the computer picks up as many execution conditions for simulation as the candidate condition number for each expression and each cell. In subsequent step S15, the computer calculates the value of each coefficient by using the result of each simulation under the picked-up execution conditions for each cell and each expression, and evaluates an error between the simulation result and the expression to which the calculated value of each coefficient has been substituted.

After the evaluation of an error, the process proceeds to step S16, where the computer determines whether or not the processes have been repeated a prescribed number of times (the number of times that the pick-up was conducted). When the processes of step S14 and step S15, i.e., the calculation of the value of each coefficient by using the simulation results of the picked-up execution conditions and the evaluation of an error, have been conducted the number of times that the pick-up was conducted, the determination result in step S16 is YES, and the process proceeds to step S17. When the processes in step S14 and step S15 have not been conducted the number of times that the pick-up was conducted, the determination result in step S16 is NO, and process returns to step S14. Thereby, the computer picks up combinations of as many different execution conditions as the candidate condition number for each expression and each cell in step S14. The pick-up in that case may be executed by changing all execution conditions that were picked up previously, or may also be executed by changing part of those execution conditions. Accordingly, methods adopted for picking up execution conditions for the second or subsequent times are not particularly limited.

In step S17, the computer compares obtained errors, which exist in as many a number as the number of times that the pick-up was conducted for each expression and each cell, determines the smallest error, and determines as the library generation condition 43a the combination of execution conditions for simulation that leads to the determined error. Thereafter, the computer terminates this library generation condition determination process.

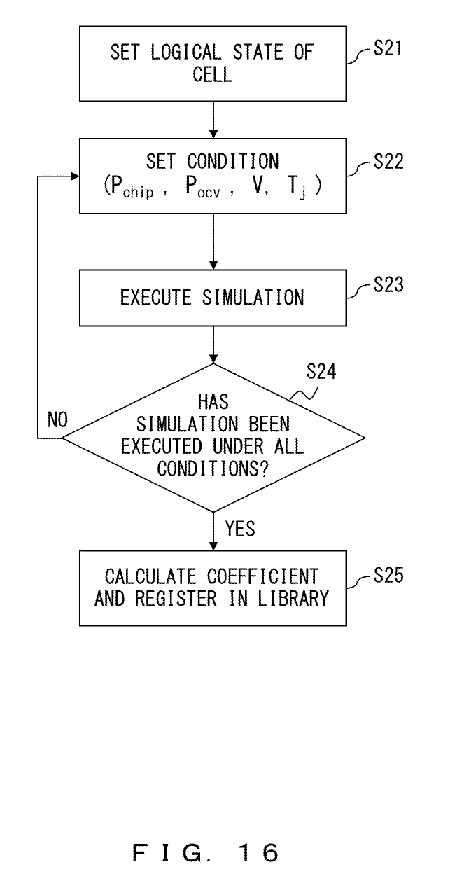

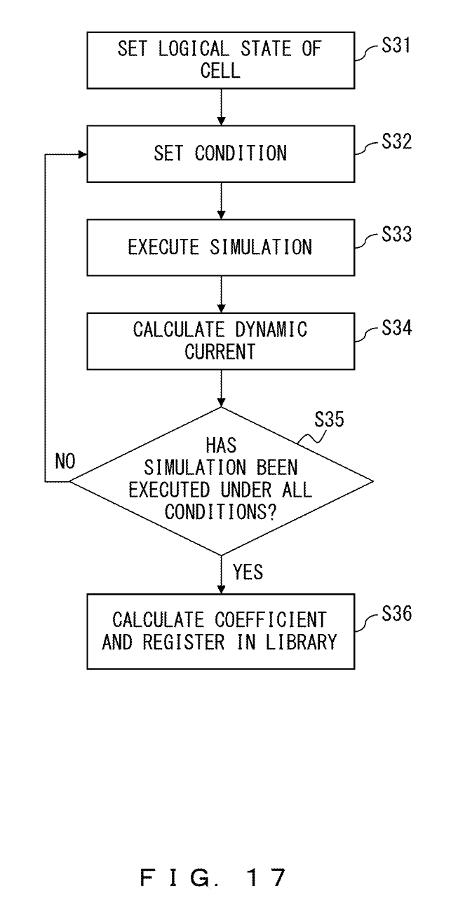

FIG. 16 is a flowchart for a leakage coefficient data registration process, and FIG. 17 is a flowchart for a dynamic coefficient data registration process. A leakage coefficient data registration process registers values of the respective coefficients of Expression (1) in the library 45a for each cell. A dynamic coefficient data registration process registers values of the respective coefficients of Expression (3) in the library 45a for each cell.

FIG. 16 and FIG. 17 represent extracts from processes executed for registering coefficient data for one logical state of a cell in the library 45a. In practice, however, the leakage coefficient data registration process and the dynamic coefficient data registration process register in the library 45a coefficient data for each logical state of each cell. For example, the leakage coefficient data registration process and the dynamic coefficient data registration process are executed in the same subroutine process. This subroutine process (referred to as a “coefficient library generation process” hereinafter) executes the leakage coefficient data registration process and the dynamic coefficient data registration process after, for example, generating the library 45a as a new library. Thereby, coefficient data generated by the leakage coefficient data registration process and the dynamic coefficient data registration process is registered in the newly generated library 45a. Accordingly, the coefficient library generation unit 44 is implemented by execution of a coefficient library generation process by a computer. In this example, the leakage coefficient data registration process will be explained in detail by referring to FIG. 16.

First, in step S21, the computer sets the logical state (input condition, internal state, or the like) of a cell that is the current target. In step S22, the computer refers to the library generation condition 43a so as to set execution conditions for simulation. Expression (1) includes process variations P_{chip} and P_{ocv}, power-supply voltage V, and junction temperature Tⱼ as conditional variables. Accordingly, execution of step S22 sets the values of process variations P_{chip} and P_{ocv}, power-supply voltage V, and junction temperature Tⱼ as execution conditions for simulation.

In step S23, subsequent to step S22, the computer executes a simulation under execution conditions that have been set, and the leakage current is measured. In step S24, which is executed next, whether or not simulation has been executed under all execution conditions registered in the library generation condition 43a for Expression (1) is determined. When there are no other execution conditions under which simulation has to be executed, the determination result in step S24 is yes, and the process proceeds to step S25. When there are other execution conditions under which simulation has to be executed, the determination result in step S24 is No, and the process returns to step S22.

In step S25, the computer calculates the value of each coefficient of Expression (1) by using all execution results of simulation, i.e., by using all leakage currents that have been measured, and registers, in the library 45a, the calculated value of each coefficient as coefficient data of one logical state of the target cell. Thereafter, the leakage coefficient data registration process of the portion illustrated in FIG. 16 is terminated.

The computer that executes step S22 again selects and sets an execution condition under which simulation has not been executed from among all execution conditions registered in the library generation condition 43a for Expression (1). Accordingly, the process loop of step S22 through step S24 is repeated until the determination result in step S24 becomes Yes, and thereby simulation is executed under all conditions for generating leakage coefficient data of one logical state of one cell.

Next, detailed explanations will be given for a dynamic coefficient data registration process by referring to FIG. 17.

First, in step S31, the computer sets the logical state (input/output relationship, internal state, situation condition, etc.) of a cell that is the current target. In subsequent step S32, the computer refers to the library generation condition 43a so as to set execution conditions for simulation. Expression (3) includes, as conditional variables, process variation P_{chip}, power-supply voltage V, transition times Tₛᵢₙ and Tₛₒᵤₜ, and junction temperature T. Expression (2) includes, as conditional variables, switching time T_{sw}. Accordingly, the execution of the process of step S32 sets, as execution conditions for simulation, the values of process variation P_{chip}, power-supply voltage V, transition times Tₛᵢₙ and Tₛₒᵤₜ, switching time T_{sw} (operation frequency f), and junction temperature Tⱼ.

In step S33, subsequent to step S32, the computer executes simulation under the set execution conditions, and measures the average current value during one switching time T_{sw} and measures the leakage current value under each of the situations where a signal that changes the level is L or H. In subsequent step S34, the computer uses the measurement results in step S33 so as to calculate the dynamic current value. In an example of calculation of a dynamic current value, the leakage current value in each of the situations where a signal that changes the level is L or H, and the value of the current to be charged to the load 60 (the maximum charge that can be stored in the load 60=C_{load} V) are subtracted from the average current value during one switching time T_{sw}. After the above calculation of a dynamic current value, the process proceeds to step S35.

In step S35, the computer determines whether or not simulation has been executed under all execution conditions registered in the library generation condition 43a for Expression (3). When there are no other execution conditions under which simulation has to be executed, the determination result in step S35 is yes, and the process proceeds to step S36. When there are other execution conditions under which simulation has to be executed, the determination result in step S35 is No, and the process returns to step S32.

In step S36, the computer uses all execution results of simulation to calculate the value of each coefficient of Expression (3), and registers the calculated values in the library 45a as coefficient data of one logical state of the target cell. Thereafter, the dynamic coefficient data registration process of the portion illustrated in FIG. 17 is terminated.

The computer that again executes step S32 selects and sets an execution condition under which simulation has not been executed from among all execution conditions registered in the library generation condition 43a for Expression (3). Accordingly, the process loop of step S32 through step S35 is repeated until the determination result in 35 becomes Yes, and thereby simulation is executed under all conditions for generating dynamic coefficient data of one logical state of one cell.

The processes of the portions illustrated in FIG. 16 and FIG. 17 are repeated for each logical state in the same cell. As a result of this, coefficient data is registered in the library 45a for each logical state of one cell. By repeating similar processes in each cell, generation of the library 45a in which coefficient data is registered for each logical state of each cell is completed. After the completion of generation of the library 45a, the coefficient library generation process is terminated.

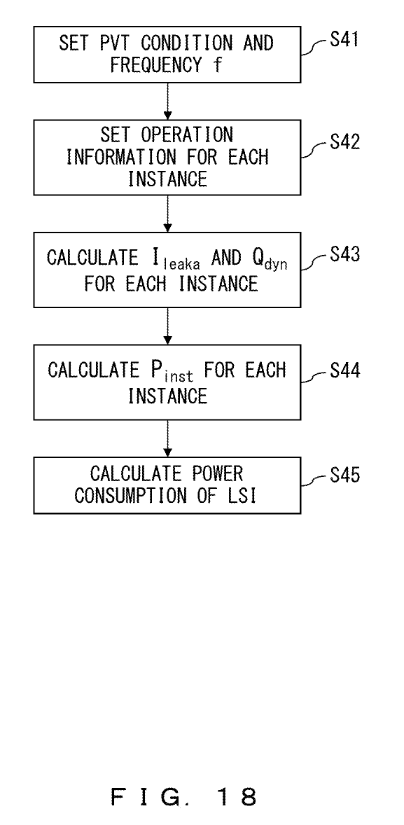

FIG. 18 is a flowchart of a power consumption calculation process. This process calculates the power consumption value of an LSI by using the library 45a, and is implemented by the power consumption calculation program described above. The instance-by-instance power consumption calculation unit 47 and the LSI power consumption calculation unit 48 are implemented by execution of the power consumption calculation process by a computer.

First in step S41, a computer performs various settings in accordance with operations input by an operator to the input device 73. For example, an operator operates the input device 73 so as to specify an LSI (for example, a net list) whose power consumption is to be evaluated, the PVT (process variation P_{chip}, power-supply voltage V, and junction temperature Tⱼ) condition 46, operation frequency f, the library 45a to be used for evaluating the power consumption, etc. Thereby, setting is performed in accordance with those specified elements. After performing the various settings, the process proceeds to step S42. Switching time T_{sw} corresponds to the inverse number of operation frequency f.

In step S42, the computer refers to, for example, a net list so as to set operation information for each instance. After operation information has been set for all instances, the process proceeds to step S43.

Operation information is necessary to evaluate power consumption, in addition to the PVT condition 46a. Specifically, operation information includes availability ratio α, input transition time Tₛᵢₙ, output transition time Tₛₒᵤₜ, and load capacity C_{load}.

Availability ratio α is information representing a ratio at which a corresponding instance operates, and is a value between, for example, zero and one. Availability ratio α may be set (calculated) for each instance by using the results of logical simulation or the like; however, it may also be set for each LSI block, each type of circuit (types categorized by whether it is a conditional circuit, a permutation circuit, a clock source, or the like) adopted as a cell, or for any combination thereof. A target of setting availability ratio α is selected in accordance with, for example, the accuracy required in evaluating the power consumption. When a plurality of instances are targeted, it is possible to calculate the average value or the like of availability ratios α so as to assign the average value to the respective instances.

Input transition time Tₛᵢₙ, output transition time Tₛₒᵤₜ, and load capacity C_{load} may be set by using the results of, for example, STA (Static Timing Analysis), which is used for verifying timings. This setting may be performed for each instance. However, it may also be set for each LSI block, each type of circuit (types categorized by whether it is a conditional circuit, a permutation circuit, a clock source, or the like) adopted as a cell, or for any combination thereof. A target of setting these values is selected in accordance with, for example, the accuracy required in evaluating the power consumption. When a plurality of instances are targeted, it is possible to calculate the average value or the like of respective values so as to assign the average value to the respective instances.

In step S43, the computer refers to the library 45a for each instance by using the set PVT condition 46a and operation information so as to calculate average leakage current value Iₗₑₐₖₐ and consumed charge quantity Q_{dyn} from Expressions (1) and (3). In subsequent step S44, the computer calculates power consumption value Pᵢₙₛₜ by using the averaged average leakage current value Iₗₑₐₖₐ and consumed charge quantity Q_{dyn} for each instance. Calculation of power consumption value Pᵢₙₛₜ is performed by using, for example, the following expression.

Pᵢₙₛₜ=(Iₗₑₐₖₐ+(Q_{dyn}+C_{load}*V)·f·α)·V (14)

After calculating power consumption value Pᵢₙₛₜ for all instances by using Expression (14), the process proceeds to step S45, and the computer accumulates power consumption values Pᵢₙₛₜ obtained for respective instances so as to calculate the power consumption value 49 of the entire LSI. After storing or outputting the calculated power consumption value 49, this power consumption calculation process is terminated.

As described above, the power consumption value 49 of a specified LSI is calculated by using the library 45a. The library 45a corresponds to the range of PVT conditions represented by the evaluation range information 41a. Accordingly, when the power consumption value 49 is calculated by, for example, changing only the PVT conditions 46a, the power consumption value 49 under the changed PVT conditions 46a can be obtained rapidly and with a high accuracy by changing the method of specifying the PVT conditions 46a.

The present embodiment employs a configuration that enables selection of the library 45a to be used for calculating the power consumption value 49 of an LSI. This configuration is employed so that the power consumption value 49 of an LSI can be calculated under various PVT conditions 46a without newly generating the library 45a.

### Second Embodiment

The amount of heat generated in an LSI varies in accordance with power consumption. Thereby, in practice, the junction temperature Tⱼ varies in accordance with power consumption. Junction temperature Tⱼ given as the PVT condition 46a is used for obtaining a power consumption value that is unknown. Because of this as well, junction temperature Tⱼ given as the PVT condition 46a is not always appropriate. In view of this, the second embodiment automatically obtains a junction temperature Tⱼ that is more appropriate so as to reflect a more appropriate junction temperature Tⱼ on calculation of the power consumption value 49. Power consumption of an LSI can be calculated with a higher accuracy by automatically obtaining such a junction temperature Tⱼ so as to use it in calculation of the power consumption value 49.

The second embodiment is different from the first embodiment only in a power consumption calculation apparatus because calculation of the power consumption value 49 uses a junction temperature Tⱼ that has been obtained automatically. However, the power consumption calculation apparatus in the second embodiment employs a configuration that is basically similar to that of the first embodiment, and operates roughly similarly to that of the first embodiment. Thus, the power consumption calculation apparatus in the second embodiment is denoted by the same numeral that denotes that of the first embodiment, and explanations are given only for aspects that are different from those in the first embodiment.

In the second embodiment, the instance-by-instance power consumption calculation unit 47 calculates power consumption value Pᵢₙₛₜ for each instance, and thereafter analyses the temperature distribution in the LSI by using the calculated power consumption value Pᵢₙₛₜ. The temperature distribution in an LSI can be conducted by using a known heat analysis tool (program). In order to enable a heat analysis tool to perform this analysis of temperature distribution in an LSI, the instance-by-instance power consumption calculation unit 47 is given detailed-structure data, which represents a detailed structure, of an LSI (including a package portion) or a heat analysis model. In the case of an LSI that uses a heat sink, a fan, or the like for cooling, data of cooling conditions or the like is also given to the instance-by-instance power consumption calculation unit 47. Detailed-structure data and a heat analysis model may cover an LSI entirely or may cover part of an LSI.

The second embodiment uses a heat analysis tool for analyzing temperature distribution in LSIs. Accordingly, the power consumption calculation program according to the second embodiment is further provided with a function of implementing a heat analysis tool as a sub program.

The junction temperature of each instance depends upon the power consumption and the ambient temperature. The temperature distribution in an LSI gives the ambient temperature of each instance. A power consumption value may be given through calculation. Accordingly, when the temperature distribution in an LSI is determined, actual junction temperature Tⱼ of each instance may be measured (estimated).

The instance-by-instance power consumption calculation unit 47 determines whether or not junction temperature Tⱼ (specified junction temperature Tⱼ or updated junction temperature Tⱼ, which are referred to as a “current junction temperature Tⱼ” hereinafter) currently used for the calculation of power consumption value Pᵢₙₛₜ is appropriate by using a junction temperature Tⱼ that has been newly calculated through the use of the analysis result of the temperature distribution in the LSI (referred to as “new junction temperature Tⱼ” hereinafter). Accordingly, the determination of whether or not the current junction temperature Tⱼ is appropriate is performed when, for example, a difference between the junction temperature Tⱼ obtained immediately before in each instance (specified junction temperature Tⱼ or junction temperature Tⱼ obtained by calculation) and the new junction temperature Tⱼ is within a prescribed range.

When the instance-by-instance power consumption calculation unit 47 has determined that the new junction temperature Tₕ is appropriate, it outputs the power consumption value Pᵢₙₛₜ calculated for each instance to the LSI power consumption calculation unit 48. Thereby, the LSI power consumption calculation unit 48 calculates the power consumption value 49 of the entire LSI. When the instance-by-instance power consumption calculation unit 47 has determined that the new junction temperature Tⱼ is inappropriate, it sets the new junction temperature Tⱼ for calculating power consumption value Pᵢₙₛₜ so as to again perform the calculation of power consumption value Pᵢₙₛₜ of each instance and analyses the temperature distribution in the LSI by using the calculation result. As junction temperature Tⱼ to be set newly, an average value of new junction temperatures Tⱼ of respective instances, a value obtained by adding to the current junction temperature Tⱼ a value corresponding to a difference between the average value and the current junction temperature Tⱼ, or other values are possible.

As described above, the LSI power consumption calculation unit 48 determines a junction temperature Tⱼ that is appropriate to be used for calculation of power consumption value Pᵢₙₛₜ on the condition that the newly calculated junction temperature Tⱼ converges into a prescribed range. Power consumption value Pᵢₙₛₜ of each instance is eventually calculated by using the determined junction temperature Tⱼ. The use of such an appropriate junction temperature Tⱼ keeps the calculated power consumption value 49 of an LSI always highly accurate.

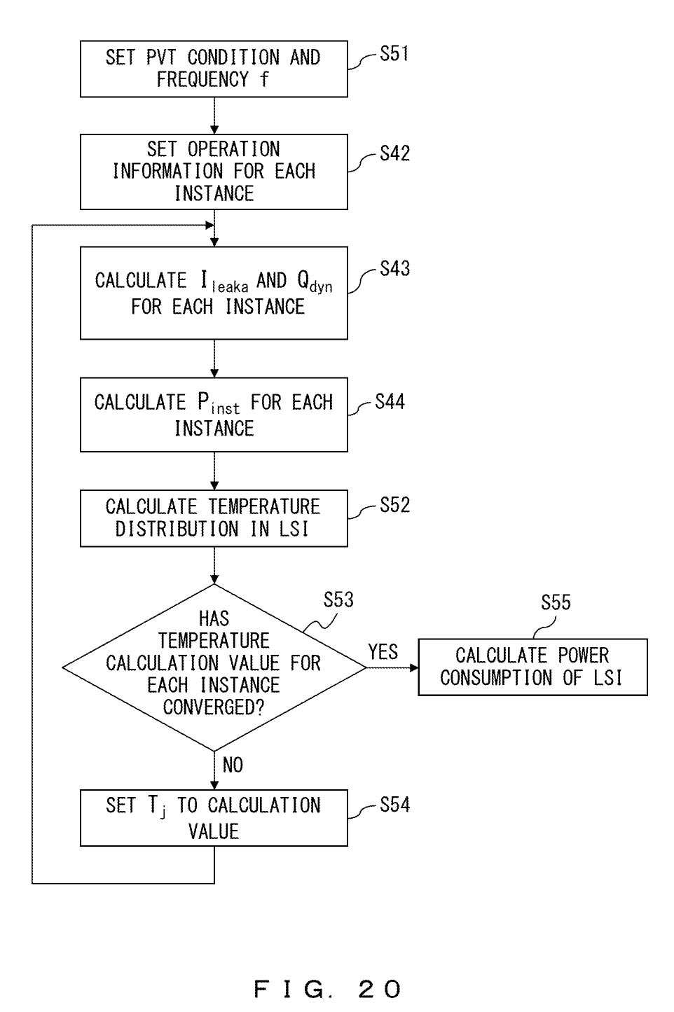

FIG. 20 is a flowchart for a power consumption calculation process according to the second embodiment. Next, the power consumption process according to the second embodiment will be explained in detail by referring to FIG. 20. In FIG. 20, the same or almost the same steps as those in the first embodiment are denoted by the same numerals. Accordingly, explanations are given by paying attention only to aspects different from those in the first embodiment.

In step S51, a computer performs various settings in accordance with operations input by an operator, similarly to the first embodiment. In the second embodiment, settings such as, for example, setting of a heat analysis tool, i.e., detailed-structure data representing the detailed structure of an LSI, setting of a heat analysis model, setting of a cooling condition, and the like are added as various settings. Junction temperature Tⱼ included in the PVT condition 46a is set as an initial value. After performing these various settings, processes in step S42 through step S44 are executed similarly to the first embodiment. After terminating the process in step S44, the process proceeds to step S52.

In step S52, the computer executes a heat analysis tool by using power consumption value Pᵢₙₛₜ calculated for each instance so as to calculate the temperature distribution in an LSI. In subsequent step S53, the computer calculates junction temperature Tⱼ of each instance (“temperature calculation value” in the figure), and determines whether or not calculated junction temperature Tⱼ has converged. When newly calculated junction temperature Tⱼ is equal, with a difference within a prescribed range (positive or negative 1° C., for example), to the initial value of junction temperature Tⱼ or the junction temperature Tⱼ that was calculated immediately before in each instance, the determination is YES, and the process proceeds to step S55. In step S55, the computer accumulates power consumption values Pᵢₙₛₜ calculated for individual instances so as to calculate the power consumption value 49. After calculating the power consumption value 49, the power consumption calculation process is terminated.

When the newly calculated junction temperature Tⱼ is not equal, with a difference within a prescribed range, to the initial value of junction temperature Tⱼ or the junction temperature Tⱼ that was calculated immediately before in each instance, the determination is NO, and the process proceeds to step S54. In step S54, the computer sets a new junction temperature Tⱼ to be used for calculation of power consumption value Pᵢₙₛₜ for each instance. New junction temperature Tⱼ is set by using junction temperature Tⱼ calculated for each instance. After setting junction temperature Tⱼ newly, the process returns to step S43.

In the present embodiments (first and second embodiments), generation of the library 45a and calculation of the power consumption value 49 of an LSI (semiconductor device) are conducted separately; however, generation of the library 45a and calculation of the power consumption value 49 of an LSI may be conducted continuously. One library 45a is generated for one piece of a given library 41a; however, a plurality of libraries 45a may be generated depending upon the size of the range represented by the evaluation range information 41a. When a plurality of libraries 45a are generated, the generation of libraries 45a requires a longer period of time; however, the accuracy in evaluating power consumption can be increased further.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A non-transitory computer-readable storage medium having stored therein a program for causing a computer to execute a process comprising:
obtaining range information representing a range of an evaluation condition under which a power consumption value of a semiconductor device is calculated;
setting a mathematical expression for calculating a power consumption value of a cell under an evaluation condition within the range represented by the range information for each cell, which is a basic element constituting the semiconductor device; and
generating a library that has stored mathematical expression information representing the set mathematical expression for each of the cells.

2. The medium according to claim 1, wherein:
the evaluation condition whose range is represented by the range information includes a PVT condition that represents a variation in a process of producing the semiconductor device, a voltage to be applied to the cell, and a temperature of the cell.

3. The medium according to claim 2, wherein:
the setting of a mathematical expression for each of the cells is performed by:
selecting at least one first cell from among the cells that constitute the semiconductor device;
determining a first simulation condition group under which simulation is conducted for obtaining a consumed current of the first cell from the range represented by the range information;
conducting simulation of the first cell under the first simulation condition group;
determining a second simulation condition group under which simulation is conducted for a second cell different from the first cell on the basis of a result of the simulation under the first simulation condition group;
conducting at least simulation for obtaining the consumed current of the second cell under the second simulation condition group; and
using a result of simulation under one of the first and second simulation condition groups.

4. The medium according to claim 3, wherein:
the setting of a mathematical expression for each of the cells is performed by:
determining a value of each coefficient included in a mathematical expression that is prepared beforehand, by using a result of simulation under one of the first and second simulation condition groups.

5. A library generation apparatus, comprising:
a processor that implements functions including:
an information obtainment unit configured to obtain range information representing a range of an evaluation condition under which a power consumption value of a semiconductor device is calculated;
a mathematical expression setting unit configured to set a mathematical expression for calculating a power consumption value of a cell under an evaluation condition within the range represented by the range information obtained by the information obtainment unit, for each cell, which is a basic element constituting the semiconductor device; and
a library generation unit configured to generate a library that has stored, for each of the cells, mathematical expression information representing the mathematical expression set by the expression setting unit.

6. A medium for causing a computer to execute a process comprising:
obtaining an evaluation condition under which a power consumption value of a semiconductor device is calculated;
performing calculation of a power consumption value under the evaluation condition of a cell, which is a basic element included in the semiconductor device, by using a library that has stored, for each of the cells, mathematical expression information representing a mathematical expression to be used for calculating the power consumption value; and
calculating the power consumption value under the evaluation condition of the semiconductor device by using the power consumption value calculated for each of the cells by using the library.

7. The medium according to claim 6, wherein:
the evaluation condition includes a temperature of the cell; and
the power consumption value of each cell is calculated by treating, as an initial value, the temperature of the cell represented by the evaluation condition, and by determining a temperature appropriate as a temperature of the cell.

8. A power consumption calculation apparatus, comprising:
a processor that implements functions including:
a condition obtainment unit configured to obtain an evaluation condition under which a power consumption value of a semiconductor device is calculated;
a first power consumption calculation unit configured to perform calculation of a power consumption value under the evaluation condition, obtained by the condition obtainment unit, of a cell, which is a basic element included in the semiconductor device, by using a library that has stored, for each of the cells, mathematical expression information representing a mathematical expression to be used for calculating the power consumption value; and
a second power consumption calculation unit configured to calculate the power consumption value under the evaluation condition of the semiconductor device by using the power consumption value calculated by the first power consumption calculation unit for each of the cells by using the library.

9. A library, comprising:
identification information that represents at least a cell, which is a basic element constituting a semiconductor device; and
mathematical expression information that is defined for each of the pieces of identification information and that represents a mathematical expression for calculating a power consumption value of a cell identified by the identification information.
